(19) United States
(12) Patent Application Publication
(10) Pub. No.: US 2024/0048786 A1
(43) Pub. Date: Feb. 8, 2024

(54) SYSTEMS AND METHODS FOR ARTIFICIAL INTELLIGENCE ENABLED PLATFORM FOR INFERENTIAL DETERMINATION OF VIEWER GROUPS AND THEIR CONTENT INTERESTS

(71) Applicant: Wild Brain Family International Limited, London (GB)

(72) Inventors: Steven JONES, Lancing Sussex (GB); William MAHMOOD, London (GB); Jai PANCHOLI, London (GB)

(73) Assignee: Wild Brain Family International Limited, London (GB)

(21) Appl. No.: 18/381,396

(22) Filed: Oct. 18, 2023

Related U.S. Application Data
(63) Continuation of application No. PCT/EP2022/063362, filed on May 17, 2022.
(60) Provisional application No. 63/189,465, filed on May 17, 2021.
(60) Provisional application No. 63/342,294, filed on May 16, 2022.

(51) Int. Cl. H04N 21/258; H04N 21/25; H04N 21/2668; H04N 21/81

(52) U.S. Cl. CPC H04N 21/25883; H04N 21/252; H04N 21/2668; H04N 21/812

(57) ABSTRACT

A computer-implemented method of determining a demographic associated with a viewer that watches a selected video is provided. The method includes receiving, at a computing device having one or more processors, video data including applied data and referral data. The applied data includes metadata that describes content of a first collection of videos. The referral data includes data associated with a second collection of videos that were previously viewed before the selected video and referred to the selected video. A taxonomy of content is generated that classifies an audience type of the video data. An audience model is generated based on the taxonomy. The audience model has a dataset related to at least one of age and gender of the viewer that watches the selected video. An affinity of the viewer toward a particular video is determined based on the taxonomy of the content.

### CROSS-REFERENCE TO RELATED APPLICATIONS

This application is a continuation of International Application No. PCT/EP2022/063362 filed May 17, 2022, which claims the benefit of U.S. Patent Application No. 63/189,465 filed May 17, 2021, and U.S. Patent Application No. 63/342,294 filed May 16, 2022. The disclosures of the above applications are incorporated herein by reference.

### FIELD

The present disclosure relates generally to computer systems and computer-implemented methods for an artificial intelligence enabled platform and, more particularly, to a computer system and related method that predicts audience demographics, viewing trends and audience behavior across a network of video content channels.

### BACKGROUND

In recent years with the introduction of broadband media and increased communication speed, the internet has become a desired vehicle to consume video content. Hosting and distribution systems, such as YouTube® provide a content hub where users can access and view various media according to a user's interests. YouTube® can facilitate suggestions to a user as to what video may be of interest to watch next based on a user's viewing history.

To support the content available to the various hosting and distribution systems, many forms of advertising can be delivered to the viewers. Advertisers look to direct advertising around content on the hosting and distribution systems that best promote their products or services and to viewing audiences most receptive to such advertising. In many instances, information about individuals in the audience or subsets of the audience are known. In these examples, related viewing content, point of sale information, previous visited websites and further information can be provided one or more individuals in the viewing audience. In many other instances, information about individuals in the audience are unknown and lack any further information about related viewing content, point of sale information, previous visited websites, etc., which can be necessitated due to choice of the user and/or various laws and regulations governing privacy, data, and personal information.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method of determining a demographic associated with a viewer that watches a selected video is provided. The method includes receiving, at a computing device having one or more processors, video data including applied data and referral data. The applied data includes metadata that describes content of a first collection of videos. The referral data includes data associated with a second collection of videos that were previously viewed before the selected video and referred to the selected video.

The video data is stored at the computing device. A taxonomy of content is generated that classifies an audience type of the video data. The taxonomy is stored at the computing device. An audience model is generated based on the taxonomy. The audience model has a dataset related to at least one of age and gender of the viewer that watches the selected video. An affinity of the viewer toward a particular video is determined based on the taxonomy of the content.

According to additional embodiments, a first timeframe of viewing the selected video from a first viewer that previously watched a first prior video is identified. A second timeframe of viewing the selected video from a second viewer that previously watched a second prior video is identified. A determination is made whether the first timeframe or the second timeframe is longer. A greater affinity is assigned to the respective first and second prior video based on the determined longer timeframe.

In other embodiments, clusters of videos are generated that share characteristics with the audience model. Future content is targeted based on the clusters of videos. In some examples, the future content comprises future videos. In other embodiments the future content comprises advertising. The characteristics can comprise a gender of the viewer that watches the selected video. The characteristics can additionally or alternatively comprise an age range of the viewer that watches the selected video. The age range can be a viewer under 13 years old. The age groups can be selected from at least one of 0-3 years, 3-5 years, 5-8 years and over 8 years. In embodiments the characteristic can comprise a geographic location of the viewer that watches the video.

According to additional embodiments, a content model can be generated having a dataset related to production style. The production style can comprise one of animation and live action. Generating the content model can include receiving an image thumbnail of the selected video and determining whether the production style is one of animation and live action based on the image thumbnail.

In other embodiments, a content model can be generated having a dataset related to a genre of the video data. In examples, the genre comprises at least one of arts, crafts, friends, family, transportation, sports and games. In other embodiments, a content model can be generated having a dataset related to keywords. The video data can further comprise an amount of views of the videos in the first and second collection of videos. The video data can further comprise a watch time of videos in the first and second collection of videos. The video data can further comprise a country that videos in the first and second collection of videos are being watched in. The video data can further comprise a channel that videos on the first and second collection of videos are being watched on.

A computer-implemented method of determining a characteristic associated with a selected video is provided. The method includes receiving, at a computing device having one or more processors, video data including applied data and referral data. The applied data includes metadata that describes content of a first collection of videos. The referral data includes data associated with a second collection of videos that were previously viewed before the selected video and referred to the selected video. The video data is stored at the computing device. A taxonomy of content is generated that classifies a content type of the video data. The taxonomy is stored at the computing device. A content model is generated based on the taxonomy. The content model has a dataset related to at least one of production style, genre and keywords of the selected video. An affinity of the viewer toward a particular video is determined based on the taxonomy of the content.

According to additional embodiments, a first timeframe of viewing the selected video from a first viewer that previously watched a first prior video is identified. A second timeframe of viewing the selected video from a second viewer that previously watched a second prior video is identified. A determination is made whether the first timeframe or the second timeframe is longer. A greater affinity is assigned to the respective first and second prior video based on the determined longer timeframe.

In other embodiments, clusters of videos are generated that share characteristics with the audience model. Future content is targeted based on the clusters of videos. In some examples, the future content comprises future videos. In other embodiments the future content comprises advertising.

According to additional embodiments, a content model can be generated having a dataset related to production style. The production style can comprise one of animation and live action. Generating the content model can include receiving an image thumbnail of the selected video and determining whether the production style is one of animation and live action based on the image thumbnail.

In other embodiments, a content model can be generated having a dataset related to a genre of the video data. In examples, the genre comprises at least one of arts, crafts, friends, family, transportation, sports and games. In other embodiments, a content model can be generated having a dataset related to keywords. The video data can further comprise an amount of views of the videos in the first and second collection of videos. The video data can further comprise a watch time of videos in the first and second collection of videos. The video data can further comprise a country that videos in the first and second collection of videos are being watched in. The video data can further comprise a channel that videos on the first and second collection of videos are being watched on.

A computer system includes at least one processor configured to receive, at a computing device having one or more processors, video data including applied data and referral data. The applied data includes metadata that describes content of a first collection of videos. The referral data includes data associated with a second collection of videos that were previously viewed before the selected video and referred to the selected video. The video data is stored at the computing device. A taxonomy of content is generated that classifies an audience type of the video data. The taxonomy is stored at the computing device. An audience model is generated based on the taxonomy. The audience model has a dataset related to at least one of age and gender of the viewer that watches the selected video. An affinity of the viewer toward a particular video is determined based on the taxonomy of the content.

A computing device includes one or more processors and a non-transitory computer-readable storage medium having multiple instructions stored thereon, which, when executed by the one or more processors, cause the one or more processors to perform operations including: receiving, at the one or more processors, video data including applied data and referral data. The applied data includes metadata that describes content of a first collection of videos. The referral data includes data associated with a second collection of videos that were previously viewed before the selected video and referred to the selected video. The video data is stored at the computing device. A taxonomy of content is generated that classifies an audience type of the video data. The taxonomy is stored at the computing device. An audience model is generated based on the taxonomy. The audience model has a dataset related to at least one of age and gender of the viewer that watches the selected video. An affinity of the viewer toward a particular video is determined based on the taxonomy of the content.

A non-transitory computer-readable storage medium having multiple instructions executable by a control circuit for a computer system including: receiving, at a computing device having one or more processors, video data including applied data and referral data. The applied data includes metadata that describes content of a first collection of videos. The referral data includes data associated with a second collection of videos that were previously viewed before the selected video and referred to the selected video. The video data is stored at the computing device. A taxonomy of content is generated that classifies an audience type of the video data. The taxonomy is stored at the computing device. An audience model is generated based on the taxonomy. The audience model has a dataset related to at least one of age and gender of the viewer that watches the selected video. An affinity of the viewer toward a particular video is determined based on the taxonomy of the content.

### BRIEF DESCRIPTION OF THE DRAWINGS

The present disclosure will become more fully understood from the detailed description and the accompanying drawings, wherein:

FIG. 1 is a schematic diagram of an artificial intelligence enabled platform in accordance with the many examples of the present disclosure;

FIG. 2 is a schematic diagram of an exemplary architecture of the platform of FIG. 1;

FIG. 3 is a schematic illustration of a video classification system that implements a model and algorithm module set forth in FIG. 2;

FIG. 4 is a schematic diagram illustrating an exemplary mapping of video clusters by the platform of FIG. 1;

FIG. 5A illustrates an exemplary production style module provided in the model and algorithm module of FIG. 3;

FIG. 5B is a functional block diagram of the production style module of FIG. 5A;

FIG. 6A illustrates an exemplary genre/subgenre module provided in the model and algorithm module of FIG. 3;

FIG. 6B is a functional block diagram of the genre/subgenre module of FIG. 6A;

FIG. 7A illustrates an exemplary keyword module provided in the model and algorithm module of FIG. 3;

FIG. 7B is a functional block diagram of the keyword module of FIG. 7A;

FIG. 8A illustrates an exemplary age/gender module provided in the model and algorithm module of FIG. 3;

FIG. 8B is an exemplary video and channel demographic projection according to the present disclosure;

FIG. 8C is an exemplary channel audience projection according to the present disclosure;

FIG. 8D is a functional block diagram of the age/gender module of FIG. 8A;

FIG. 9A is a functional block diagram showing a sequence of using the platform of FIG. 1;

FIG. 9B is a schematic illustration of the referral metadata mining module of FIG. 9A according to one example;

FIG. 9C is a schematic illustration of the production style predictor module of FIG. 9A according to one example;

FIG. 9D is a schematic illustration of the genre predictor, the sub-genre predictor, the entity extractor and the age/gender predictor of 9A according to one example;

FIG. 10 is an exemplary core labelling output provided by the platform of the instant disclosure;

FIG. 11 is an exemplary listing of Off Network demographics uncovered by the data enrichment layer module of the present disclosure;

FIG. 12 is an exemplary listing of output predictions related to an audience profile of selected channels;

FIG. 13 is a schematic illustration showing brand affinity examples according to the present disclosure;

FIG. 14 is a schematic illustration showing examples of demographic metadata leads facilitating demographic inferences according to the present disclosure;

FIG. 15 is a flow chart showing a method of determining a demographic associated with a viewer that watches a selected video according to one example of the present disclosure;

FIG. 16 is a flow chart showing a method of determining a characteristic associated with a selected video according to one example of the present disclosure;

FIG. 17 is an exemplary brand network map generated by the artificial intelligence enabled platform according to the present disclosure;

FIG. 18 is an exemplary audience segmentation map profile generated by the artificial intelligence enabled platform according to the present disclosure;

FIG. 19 is an exemplary heat map model of age determination for a specific segment generated by the artificial intelligence enabled platform according to the present disclosure;

FIG. 20 is an exemplary heat map model of gender determination for a specific segment generated by the artificial intelligence enabled platform according to the present disclosure; and

FIG. 21 is a chart generated by the artificial intelligence enabled platform that identifies a particular characteristic or feature calculated as a function of time according to the present disclosure.

### DETAILED DESCRIPTION

It would be desirable to improve the understanding of viewing trends, audience behavior, demographics and other information and insights across various video content. In particular, it would be desirable to accurately predict demographics of viewers, including children, where privacy requirements may limit data collection at the user lever.

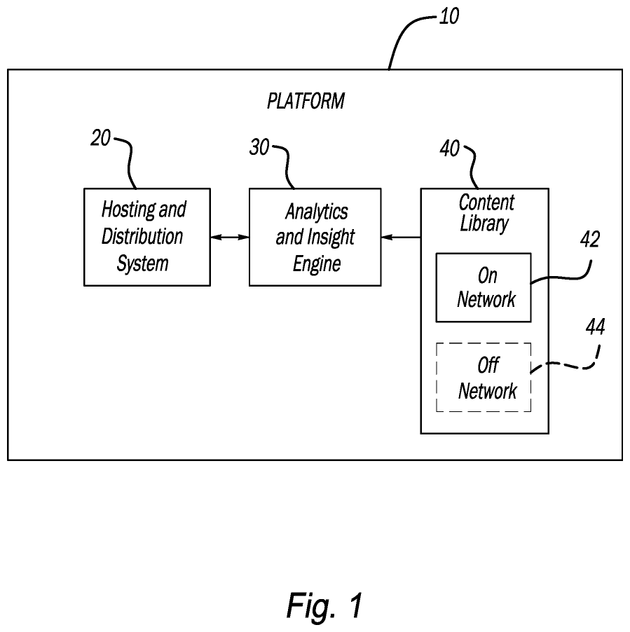

With the desire to improve the understanding of viewing trends, audience behavior, demographics and other information and insights across various video content and the desire to accurately predict demographics of viewers, including children, where privacy requirements may limit data collection at the user lever, the present disclosure provides an artificial intelligence enabled platform (hereinafter “platform”) 10 including, in various embodiments, a hosting and distribution system 20, an analytics and insights engine 30 and a content library 40, as depicted in FIG. 1.

Improving the understanding of viewer trends, audience behavior, demographics and other information and insights across various video content permits advertisers, brand owners and media creators more insightful and efficient placement of advertising and brand messaging. Moreover, advertisers, brand owners and media creators appreciate the privacy requirements sometimes mandated and/or sometimes agreed to maintain privacy of individuals while still placing insightful and efficient advertising and brand messaging applicable to the one or more viewing groups formed by such individuals. To this end, the platform 10 permits the accurate prediction of demographics of viewers, including children, where privacy requirements agreed to and/or mandated may limit (or not permit) data collection at the user level. Even with this purposeful sparse state of data for the individual user, the platform 10 can accurately predict demographics of viewers, including children, while still appreciating the various privacy requirements in the form across many scenarios.

With continuing reference to FIG. 1, the hosting and distribution system 20 can host and display content to a viewer. In one example, the hosting and distribution system 20 can include YouTube® or a similar distribution system. It is contemplated that other hosting and distribution systems may be used. The analytics and insights engine 30 can employ machine learning techniques to train and create algorithms that can identify a video based on its content. The content library 40 can store content used by the platform 10. As will become appreciated from the following discussion, the platform 10 leverages the hosting and distribution system 20, the analytics and insights engine 30 and the content library 40 to infer various characteristics including age and gender demographics as well as interests of one or more viewer groups.

In embodiments, the platform 10 can also be referred to as the WildBrain™ platform and can facilitate analytics and analyses by way of the analytics and insights engine 30 to create clusters of videos that share characteristics. The identified videos can then be suggested for viewing on the hosting and distribution system 20.

In embodiments, the platform 10 can be configured to combine and analyze different data sets (or subsets thereof) to understand viewing trends, audience behavior, demographics and other information and insights across content that may (or may not) have yet been analyzed by the analytics and insights engine 30. As will become appreciated herein, the platform 10 can be particularly valuable in making predictions about certain demographics viewing the content, such as children, where privacy requirements otherwise restrict data collection at a user level. Such predictions about viewer demographics are carried out using analysis based on contextual targeting by content type and audience type. In this regard, audience targeting can be reliably carried out for age and gender specific material targeted for children in general. The platform 10 can provide deeper analysis beyond just identifying generally that a viewer is a child and can reliably predict the gender and age range of a viewer. It will be appreciated however, that the platform 10 can be valuable in making predictions about other demographics, outside of children, within the scope of the present disclosure.

As will become appreciated herein, the content library 40 can include “On Network” content 42 and “Off Network” content 44. The On Network content 42 can include a sub-set of content managed on a predetermined network of channels under the control of the platform 10. The Off Network content 44, or referral network, can include videos that refer viewers into the On Network content 42 and not under the control of the platform 10. Regardless of where the content originates, the analytics and insight engine 30 can analyze the videos and can build a data platform to create clusters of videos particularly suited for one or more viewer groups. Furthermore, the analytics and insight engine 30 can perform actions such as advertisement targeting based on determinations as to which viewer groups are watching particular content. It will be appreciated in light of the disclosure that the analytics and insights engine 30 can more easily understand the Off Network content 44 when the analytics and insights engine 30 has analyzed the On Network content 42 and can base its generation of metadata based on the analytics and insights of similar media. It will also be appreciated in light of the disclosure that the analytics and insights engine 30 can sufficiently understand the Off Network content 44 to enrich the Off Network content 44 sufficiently to transform it or provide informational links to the On Network content 42. In further examples, the analytics and insights engine 30 can sufficiently understand the Off Network content 44 to enrich the Off Network content 44 in combination with other data obtained by the platform 10 to transform the Off Network content 44 or provide informational links to On Network content 42.

In embodiments, the platform 10 can obtain content data about media from the content library 40 within the platform 10, including through third parties. The content data can be associated with media or sets of media from the content library 40. The content data can take the form of metadata that describes the media (e.g., what is in the video), identifies a provenance of the media, or the like.

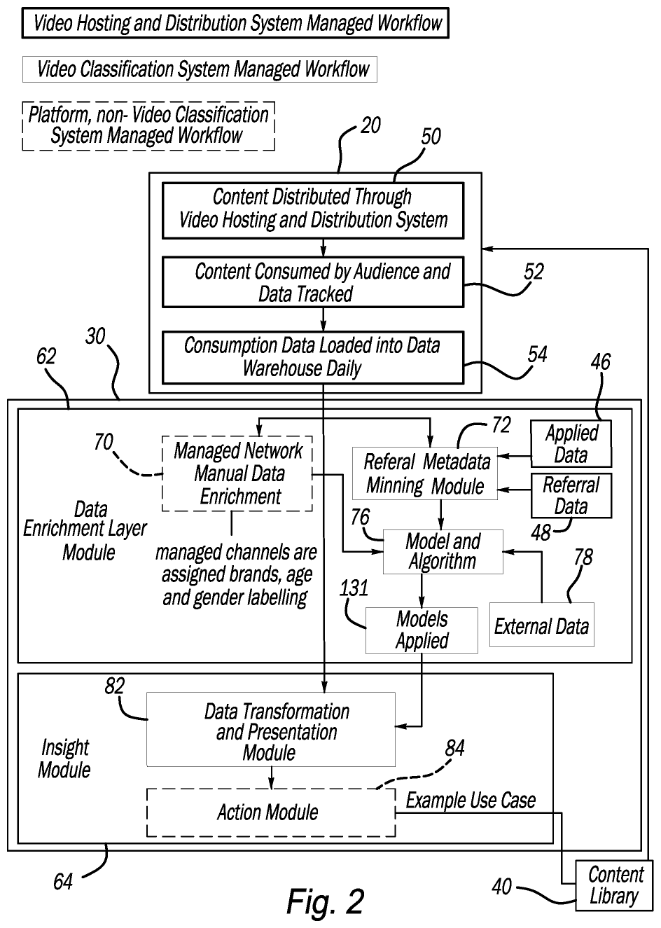

In embodiments, the platform 10 can combine and analyze different data sets to understand viewing trends and audience behavior in the On Network content 42, and in some examples in the Off Network content 44. The platform 10 leverages two content data sources, referred to herein as “applied data”, identified generally at reference 46, FIG. 2 and “referral data”, identified generally at reference 48, FIG. 2. Applied data 46 is data that is applied to content such as metadata that describes the content or identifies the provenance of the content. Referral data 48 is data that identifies the video, which was watched before the viewer reached the content already studied by the platform 10.

With additional reference now to FIG. 2, the platform 10 will be further described. The analytics and insight engine 30 is shown interacting with the hosting and distribution system 20 and the content library 40. The hosting and distribution system 20 is shown including content distributed through YouTube® 50, content consumed by an audience and data tracked 52 and consumption data loaded into data warehouse daily 54.

The analytics and insight engine 30 generally includes a data enrichment module 62 and an insight module 64. The data enrichment module 62 generally includes a managed network manual data enrichment module 70, a referral metadata mining module 72, and a model and algorithm development module 76. At the managed network manual data enrichment module 70, managed channels can be assigned brands, age and gender labelling. The referral metadata mining module 72 receives data from the On Network content 42 and the Off Network content 44 including the applied data 46 and the referral data 48. The referral metadata mining module 72 can receive information such as a channel a referral video is on, the title of the video, the meta-description and tags of the referring video. External data 78 can be received by the model and algorithm development module 76. The insight layer 64 provides a data transformation and presentation module 82. The data and presentation module 82 can transform consumption, referral and enriched data and presents that data through the hosting and distribution system 20. An action module 84 takes the insights learned from the data transformation and presentation module 82 and performs an action (advertising targeting, product placement, subject matter incorporation, etc.) based on the input from the data and presentation module 82 as will be described herein.

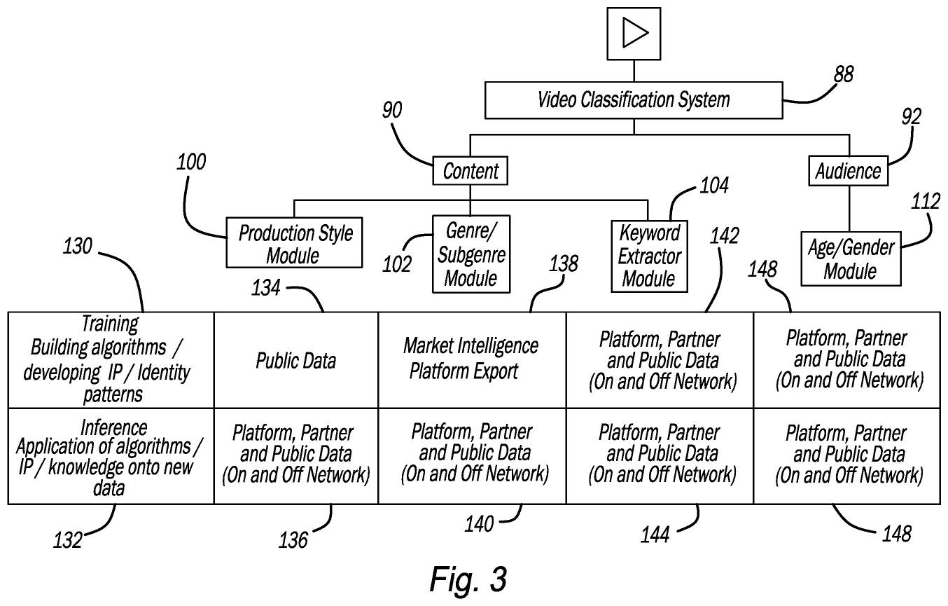

With additional reference now to FIG. 3, a video classification system 88, also referred to herein as the “Darwin™” system is shown that implements the model and algorithm development module 76. As used herein, the video classification system 88 can be a computer system that conducts a computer-implemented method, a computing device, and/or a non-transitory computer readable medium including instructions executable by a control circuit fora computer system. In one known video analytics system, provided by Tubular Labs, Inc., a taxonomy tool uses automation to classify videos. By way of example, the taxonomy examples according to an example of the present disclosure are shown grouped as a content type module 90 and an audience type module 92 The content type module 90 includes a production style module 100, a genre/subgenre module 102 and a keyword extractor module 104. The audience type module 92 includes an age/gender module 112. In embodiments, the platform 10 includes one or more taxonomies of content based on the most popular genres of content watched by a particular audience. In embodiments, the genres can include arts, crafts, friends, family, transportation, sports, games, etc. In embodiments, a particular audience is kids. In embodiments, a particular audience is kids under the age of thirteen. In embodiments, a particular audience is anyone considered applicable for protections offered under the Children's Online Privacy Protection Act (COPPA) and the like.

In embodiments, the platform 10 includes an example of a taxonomy that can be defined to include two silos (such as the content and audience type modules and 92) and multiple levels within each silo. It will be appreciated in light of the disclosure that there can be different silos and a different number of levels in each silo. By way of these examples, the platform 10 may extend or adjust such levels from time to time.

In embodiments, examples of silos can include the content type module 90 and the audience type module 92. In embodiments, examples of levels within the content type silo can include the production style module 100, the genre/subgenre module 102 and the keyword extractor module 104. The production style module 100 can include an image based model that can determine if a video is animated or live action. In examples, the production style module 100 can be enabled by machine learning as a service tool provided by a cloud computing entity (such as by Google Cloud, or other cloud computing entity) trained on a custom dataset to produce a custom model. In examples, the genre/subgenre module 102 can include multiple natural language processing enabled models that determine the content genres of videos by looking at the text metadata of the videos. In examples, open source gradient-boosted tree based learning algorithms can be trained on a specific dataset exported from a market intelligence platform. By way of example, the genre/subgenre module 102 can determine whether the content is television versus games versus music, etc.

In examples, the keyword extractor module 104 can be a natural language processing text mining method that is able to score consecutive collections of words based on their relative importance in a corpus of YouTube® titles and descriptions. Important keywords can then be extracted from the YouTube® videos. The importance has been determined through the application of tf-idf algorithms (explained herein), implemented in an open source library and trained on a proprietary dataset with custom preprocessing steps. By way of example, the keyword extractor module 104 can include television show names, characters, items appearing in the shows (toys, cars, etc.), and songs played in the shows.

The age and gender module 112 can include an algorithm that infers the age and gender of the audiences of videos from the On Network content 42 and of the videos and channels that are referred from the Off Network content 44. As will be described herein, the age and gender module 112 utilizes a manual age and gender single value labelling of channels on the On Network content 42. Audience overlap is utilized (through the referral data) to enhance the predictions of age and gender. The size of audiences of videos and channels are estimated in specified age and gender buckets.

The model and algorithm development module 76 builds algorithms using training data 130. The algorithms are applied at 131 (FIG. 2) using inference data 132. The production style module 100 uses public data 134 as training data 130. The inference data 132 used by the production style module 100 includes platform, partner and public data (on and Off Network) 136. The genre/subgenre module 102 uses market intelligence platform export data 138 as training data 130. The inference data 132 used by the genre/subgenre module 102 includes platform, partner and public data (on and Off Network) 140. The keyword extractor module 104 uses platform, partner and public data (on and Off Network) 142 and 144 for the training data 130 and inference data 132, respectively. The inference data 132 used by the age/gender module 112 includes platform, partner and public data (on and Off Network) 146. The age/gender module 112 uses platform, partner and public data (on and Off Network) 146 and 148 for the training data 130 and inference data 132, respectively.

In embodiments, sample videos typical of content across the taxonomy can be identified in the content type module 90. In these examples, machine learning and the expert systems of the analytics and insight engine 30 can be used and trained to create algorithms that can identify a video based on its content genre. It can be shown that the algorithms can be trained using media content in the On Network content 42 from the content library 40 and, as such, the platform 10 already understands such typified content in each genre of the On Network content 42. Because the platform 10 can control predetermined and in depth knowledge of the On Network content (e.g., scenarios where those who control the platform 10 can also create the content, can obtain control of the content, can be an agent, license, co-owner, etc. for the content, and so on), it can be shown that the platform 10 can deploy algorithms that can be trained by the analytics and insight engine 30 using the On Network content 42 for which the platform 10 has a relatively broader and more in depth understanding of the content across each genre. Because the platform 10 can control predetermined and in depth knowledge of the On Network content 42, it can be shown that the platform 10 can deploy algorithms that can leverage such knowledge and training associated with the On Network content 42 to better and more efficiently understand the viewer groups and their content interests of the Off Network content 44 (or for content for which there is a referral association and the platform can rely on the analytics and insight engine 30 to infer the viewer groups and their content interests).

By way of these examples, the platform 10 can include training algorithms based on raw videos that have not been pre-classified into content genres or other examples where the platform 10 may not control the content or the platform 10 may not have facilitated access to such information. By way of these examples, the platform 10 can implement the analytics and insight engine 30 to train algorithms using the On Network content 42. Once the algorithms are trained with the more familiar On Network content 42, the analytics and insight engine 30 can apply the algorithms to the less familiar Off Network content 44 to infer desired characteristics of the viewer being referred from a video in the Off Network content 44 into the On Network content 42.

In embodiments, applied audience data may be applied to videos and other content that can be managed on one or more networks affiliated with the platform 10 for which enriched audience data could be needed. In embodiments, the platform 10 can identify the expected audience based on its understanding of the audience, targets, and audience metrics from other sources (e.g., TV ratings) based on the predetermined and in depth knowledge on which the analytics and insight engine 30 was trained. In embodiments, the platform 10 can identify the expected audience based on its understanding of the audience, targets, and audience metrics from other sources based on the predetermined and in depth knowledge on which the analytics and insight engine 30 was trained.

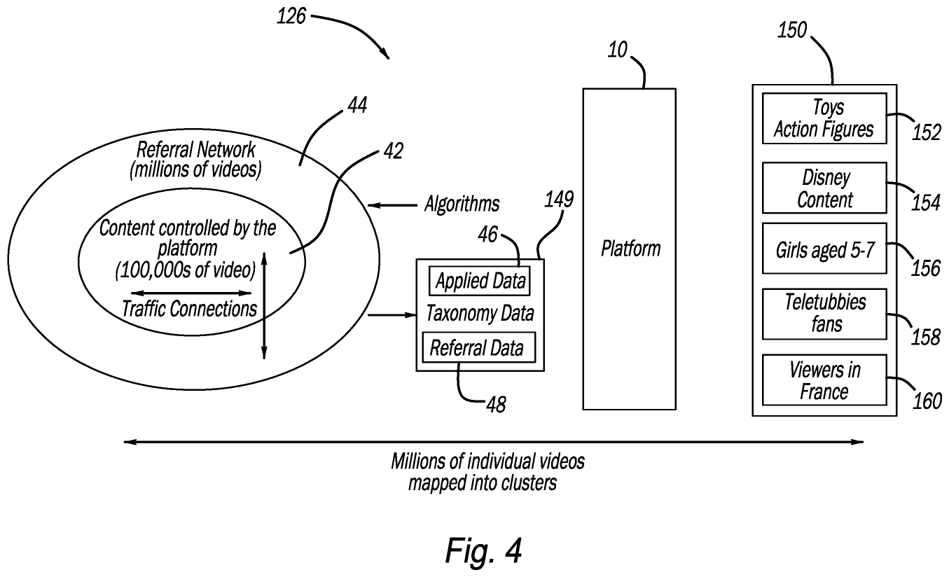

In embodiments and with additional reference to FIG. 4, the platform 10 can apply one or more algorithms to the videos included in content the platform 10 can control with its associated in depth knowledge of the On Network content by the platform 10 (such as the On Network content 42), which may be organized into a network of channels. In embodiments, the platform 10 can also apply one or more algorithms to millions of videos that refer viewers into the networks associated with the platform 10 (i.e., but not controlled or lacks such in depth knowledge by the platform 10, such as the Off Network content 44).

With additional reference to FIG. 4, the platform 10 includes algorithms that may analyze the On Network content 42 and may analyze Off Network content 44 (for which the platform 10 may not have the controlled in depth knowledge) including their referral networks. In embodiments, it can be shown that the platform 10 can be configured to facilitate classification of millions of videos into the taxonomy data 149 supported by the platform 10. In embodiments, the platform 10 can map the flows of traffic between different videos based on which video was watched immediately before one of the videos controlled by the platform 10. In these examples, the platform 10 can store all of the data obtained from the content controlled and not controlled by the platform 10 as a result of the application of the algorithms by the analytics and insight engine 30.

In embodiments, the platform 10 can facilitate one or more refreshes from time to time to keep the data platform 10 up to date with the latest audience behaviors. Once the data from the content library 40 including the On Network content 42 and the Off Network content 44 is absorbed in the platform 10, the platform 10 can facilitate analytics and analyses using the analytics and insight engine 30 to create a mapping 126 including clusters of videos 150 that share characteristics. By way of these examples, the clusters of videos 150 that share characteristics can be (i) by content genre 152 (e.g., videos involving toys and action figures); (ii) associated with a particular data tag 154 (e.g., content that's associated with a Disney® offering); (iii) an audience or demographics segment 156 (e.g., girls aged 5-7); (iv) videos watched by fans of a particular franchise 158 (e.g. Teletubbies® fans); and (v) viewers in a geographic location 160 (e.g. France). Other clusters may be identified.

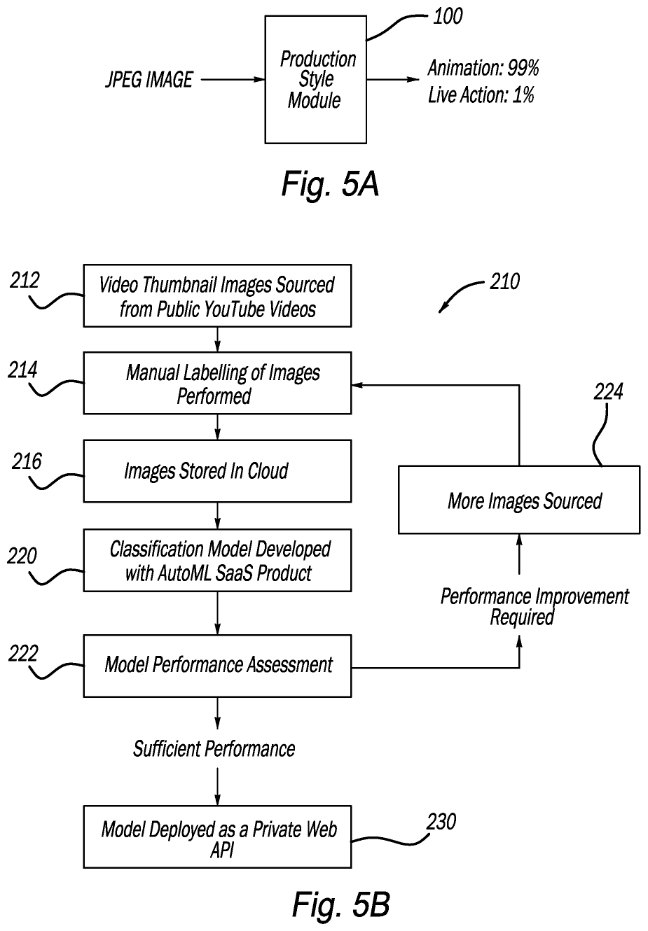

Turning now to FIGS. 5A and 5B, description of the production style module 100 will be further described. By way of example, the production style module 100 can be configured to receive an input including an image such as a jpeg image and output a predictive production of the video associated with the image. In the example shown in FIG. 5A, the production style module 100 determines a 99% likelihood that the video from where the jpeg originated has an animation production and a 1% likelihood that the video has a live action production.

As shown in FIG. 5B, steps for training the production style module 100 are shown and generally identified at reference 210. Video thumbnail images are sources from public YouTube® videos at 212. Manual labeling of images is conducted at 214. Images are stored in the Cloud at 216. As used herein, “the Cloud” can be any cloud based storage. A classification model is developed at 220 with auto machine learning software as a service (SaaS). An assessment of the performance of the production style module 100 is conducted at 222. If it is determined that an improvement in performance is needed, more images are sourced at 224. If it is determined that the production style module 100 has sufficient performance, the production style module 100 is deployed as a web application programming interface (API) at 230.

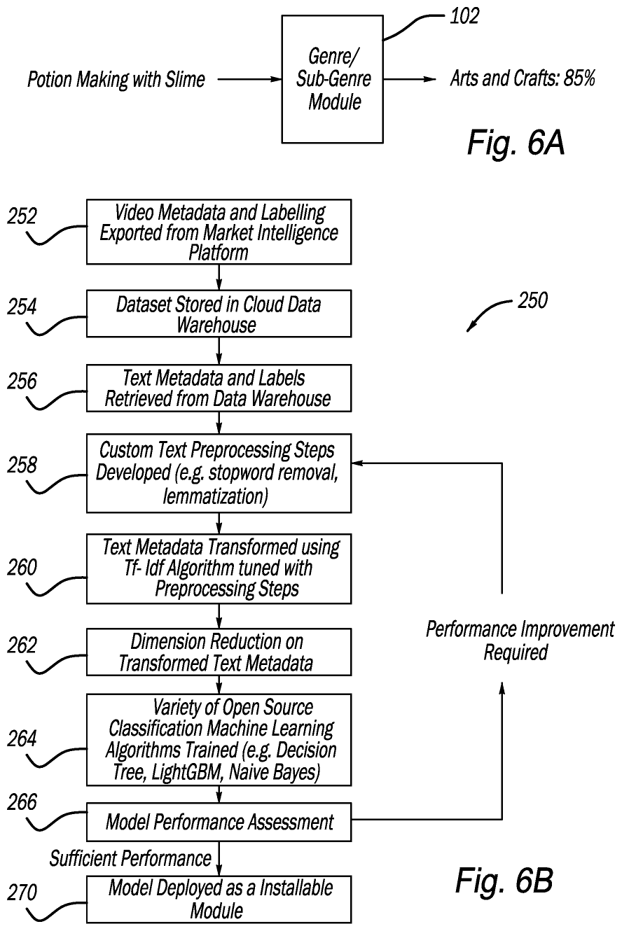

Turning now to FIGS. 6A and 6B, description of the genre/subgenre module 102 will be further described. By way of example, the genre/subgenre module 102 can be configured to receive an input related to the video. In the example shown, the input includes “potion making with slime”. The genre/subgenre module 102 can produce an output related to a predicted genre of the video, in the example shown, a prediction of 85% that the video is about “arts and crafts”. It will be appreciated that the genre/subgenre module 102 is configured to receive many other inputs related to topics for outputting a corresponding suitable subject matter.

As shown in FIG. 6B, steps for training the genre/subgenre module 102 are shown and generally identified at reference 250. Video metadata and labelling is exported from market intelligence platform at 252. The dataset is stored in cloud data warehouse at 254. Text metadata and labels are retrieved from the data warehouse at 256. Custom text preprocessing steps are developed at 258. For example, stopward removal and lemmatization can be performed. Text metadata can be transformed using term frequency-inverse document frequency (Tf-Idf) algorithm tuned with preprocessing steps at 260. The Tf-Idf algorithm can be used to quantify a word and associate a weight to each word which signifies the importance of the word. Dimension reduction on the transformed text metadata is conducted at 262. A variety of open source classification machine learning algorithms are trained at 264. By way of example, decision tree, lightGBM and naive bayes classifiers may be implemented. A model performance assessment can be performed at 266. If it is determined that an improvement in performance is needed, the method loops to 258. If it is determined that the genre/subgenre module 102 has sufficient performance, the genre/subgenre module 102 is deployed as an installable module at 270.

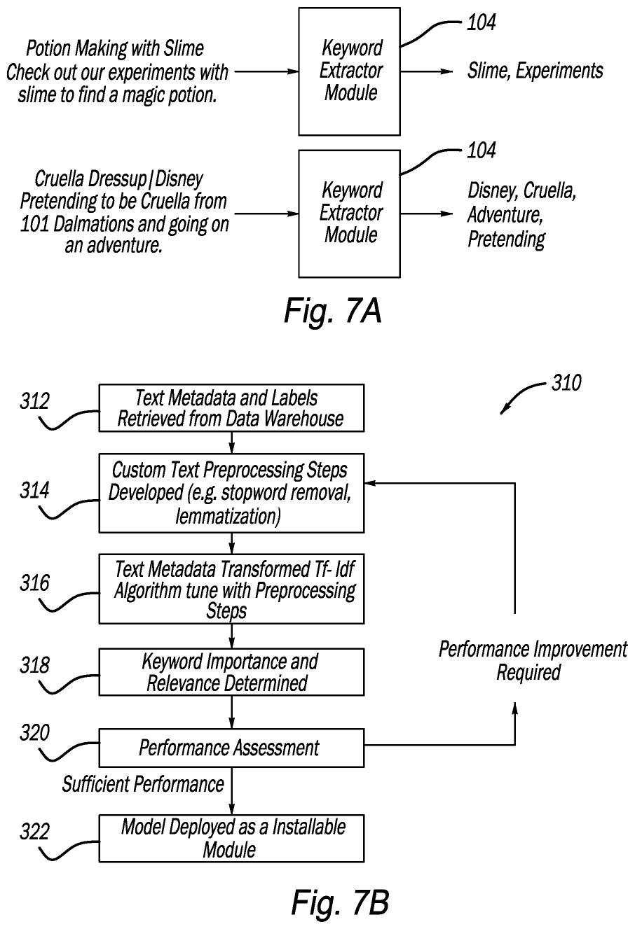

With reference now to FIGS. 7A and 7B, description of the keyword extractor module 104 will be further described. By way of example, the keyword extractor module 104 can be configured to receive an input related to a video. In a first example, the input is “potion making with slime” where a description includes “check out our experiments with slime to find a magic potion”. The keyword extractor module 104 can produce an output having keywords such as “slime” and “experiments”. In a second example, the input is “Cruella dressup|Disney” where a description includes “pretending to be Cruella from 101 Dalmatians and going on an adventure”. The keyword extractor module 104 can produce an output having keywords such as “Disney”, “Cruella”, “adventure” and “pretending”.

As shown in FIG. 7B, steps for training the keyword module 104 are shown and generally identified at reference 310. Text metadata and labels are retrieved from the data warehouse at 312. Custom text preprocessing steps are developed at 314. For example, stopward removal and lemmatization can be performed. Text metadata can be transformed using term frequency-inverse document frequency (Tf-Idf) algorithm tuned with preprocessing steps at 316. The Tf-Idf algorithm can be used to quantify a word and associate a weight to each word which signifies the importance of the word. Keyword importance and relevance are determined at 318. A performance assessment is performed at 320. If it is determined that an improvement in performance is needed, the method loops to 314. If it is determined that the keyword module 104 has sufficient performance, the keyword module 104 is deployed as an installable module at 322.

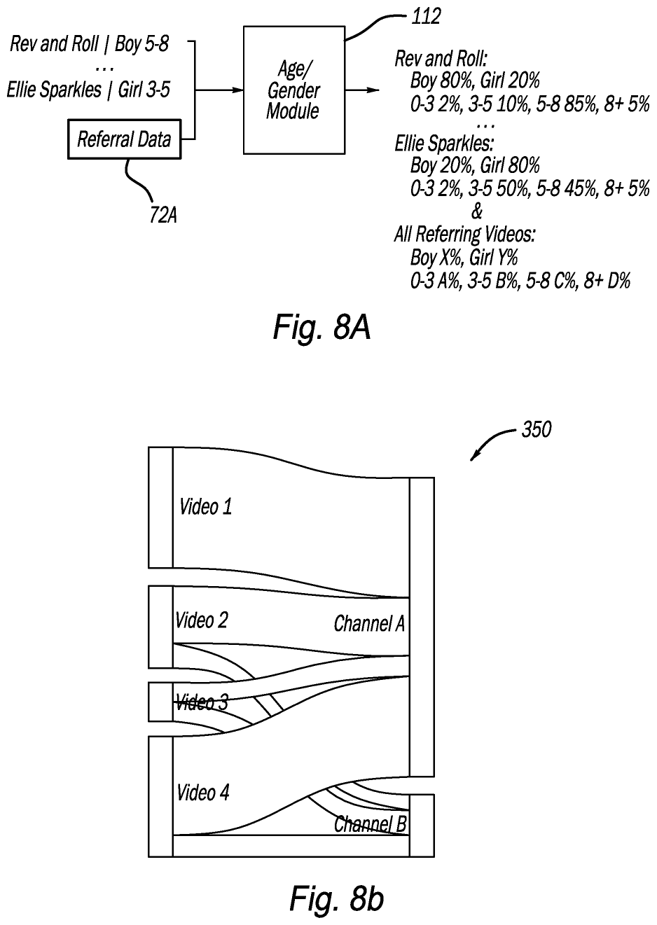

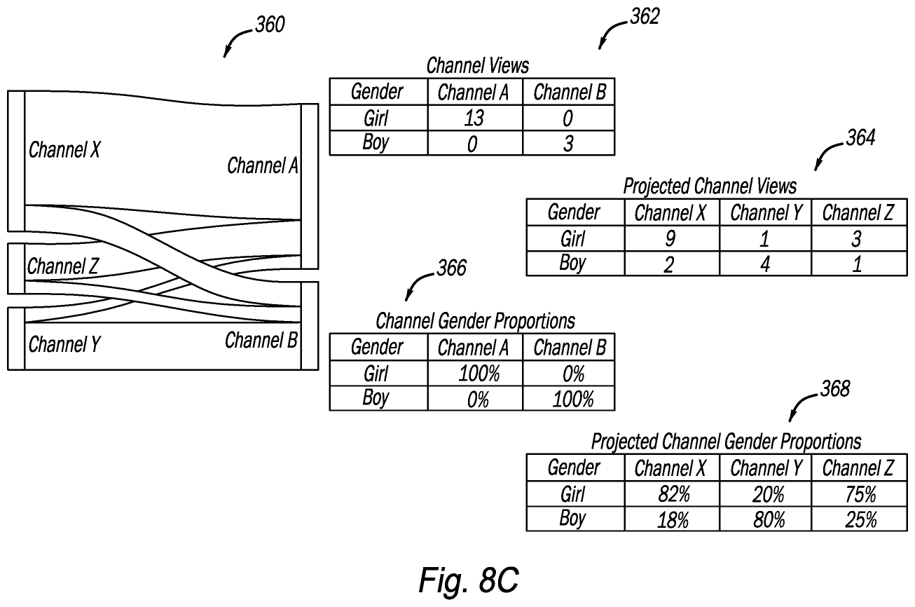

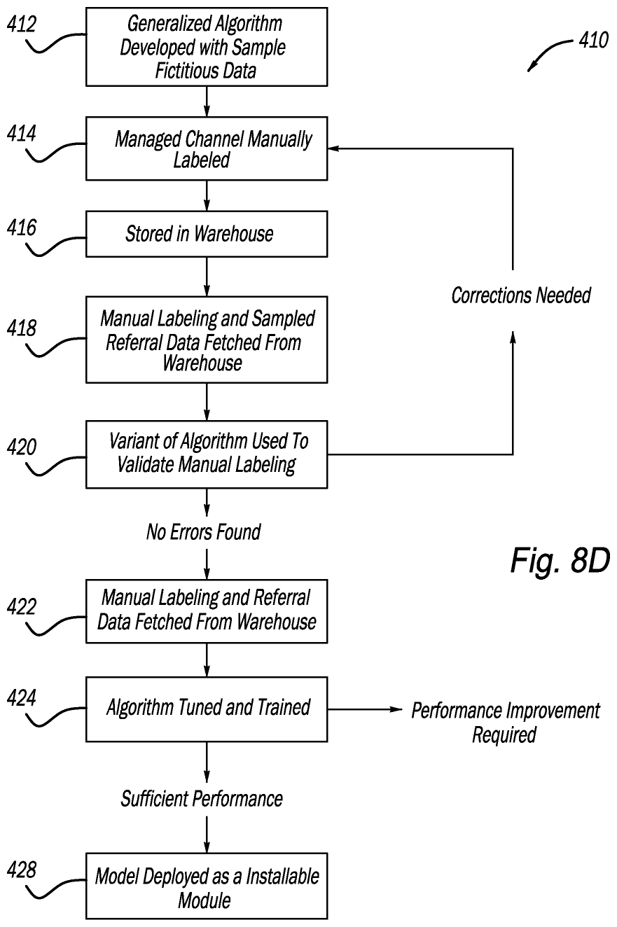

With reference now to FIGS. 8A-8D, description of the age/gender module 112 will be further described. By way of example, the age/gender module 112 can be configured to receive an input including age and gender labelling of channels from the On-network content 42. In the example shown in FIG. 8A, the program “Rev & Roll” includes a gender label of “Boy” and an age label of “5-8” years. Additionally, the program “Ellie Sparkles” includes a gender label of “Girl” and an age label of “3-5” years. It will be appreciated that many other programs and shows from the On-network content 42 can be similarly input into the age/gender module 112. Furthermore, the age/gender module 112 receives referral data 72A of videos that refer into the videos of the On-network content 42. From the input data, the age/gender module 112 can output predictions of the viewers of particular channels. For example, the age/gender module 112 predicts 80% of the viewers of “Rev & Roll” to be boys and 20% of the viewers to be girls. The age/gender module 112 further predicts 2% of the viewers of “Rev & Roll” to be “0-3” years old, 10% to be “3-5” years old, 85% to be “5-8” years old and 5% to be “8+” years old. Also by way of example, the age/gender module 112 predicts 20% of the viewers of “Ellie Sparkles” to be boys and 80% of the viewers to be girls. The age/gender module 112 further predicts 2% of the viewers of “Ellie Sparkles” to be “0-3” years old, 50% to be “3-5” years old, 45% to be “5-8” years old and 5% to be “8+” years old. In general, it can be shown that the age/gender module 112 can further make predictions on any referring video as having X % boy viewers, Y % girl viewers, A % of viewers to be 0-3 years old, B % of viewers to be 3-5 years old, C % of viewers to be 5-8 years old and D % of viewers to be 8+ years old.

As shown in FIG. 8B, a demographic projection is shown graphically at 350. A general channel demographic projection can be formulated as follows:

D_{c}(n+1)=R^{T}*∥R*D_{c}(n)μ=R^{T}*Dᵥ(n)

D_{c} (n) and Dᵥ (n) can be read as the demographic projection on a set of channels and videos at iteration n. The formula components represent R∈N^{k×m} matrix representing cross referral traffic into m managed YouTube® channels. D_{c} (0)∈R^{m×d} matrix representing initial channel audience proportions across d audience segments. ∥⋅∥ is some row norm such that row values sum to 1. Using an overlap of audiences, depicted at 360 in FIG. 8C, between more than 10,000 channels that refer into and amongst the on-network content 42, the platform 10 can project or predict the known age and genders of channels in the on-network 42 onto other channels. As depicted at 362, “Channel A” has 13 girl views and 0 boy views. “Channel B” has 0 girl views and 3 boy views. The age/gender module 112 can project, at 364, that “Channel X” will have 9 girl views and 2 boy views. “Channel Y” will have 1 girl view and 4 boy views. “Channel Z” will have 3 girl views and 1 boy view. As depicted at 366, “Channel A” has 100% girl viewers and 0% boy viewers. “Channel B” has 0% girl viewers and 100% boy viewers. The age/gender module 112 can project, at 368, that “Channel X” has 82% girl viewers and 18% boy viewers. “Channel Y” has 20% girl viewers and 80% boy viewers. “Channel Z” has 75% girl viewers and 25% boy viewers.

As shown in FIG. 8D, steps for training the age/gender module 112 are shown and generally identified at reference 410. A generalized algorithm is developed with sample fictitious data at 412. Managed channels are manually labelled at 414. At 416, the labels are stored in the warehouse. The manual labelling and sampled referral data are fetched from the warehouse at 418. A variant of the algorithm is used to validate the manual labelling at 420. If corrections are needed, the method loops to 414. If no errors are identified, the manual labelling and referral data are fetched from the warehouse at 422. The algorithm is tuned and trained at 424. If performance improvement is required, the method loops to 422. If sufficient performance is achieved, the model is deployed as an installable module at 428.

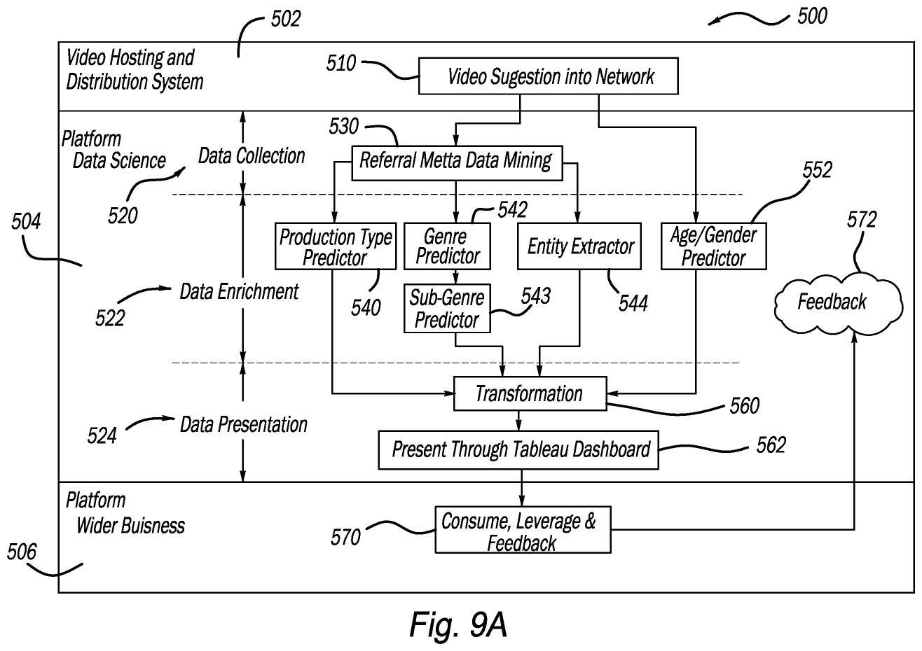

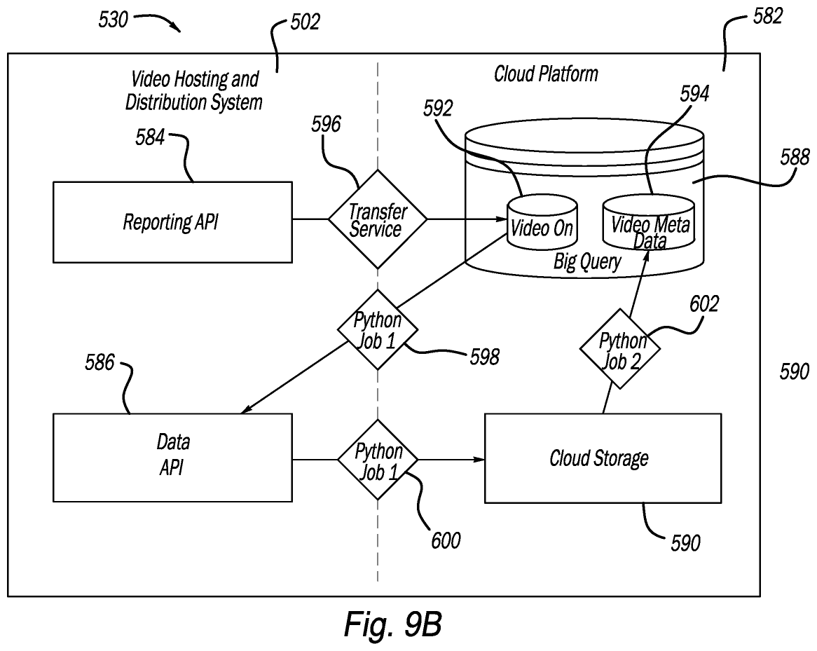

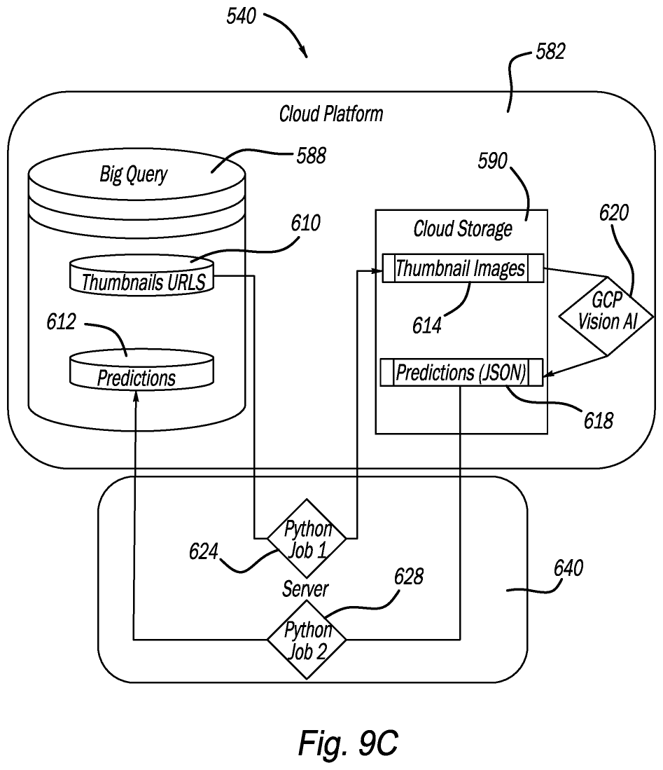

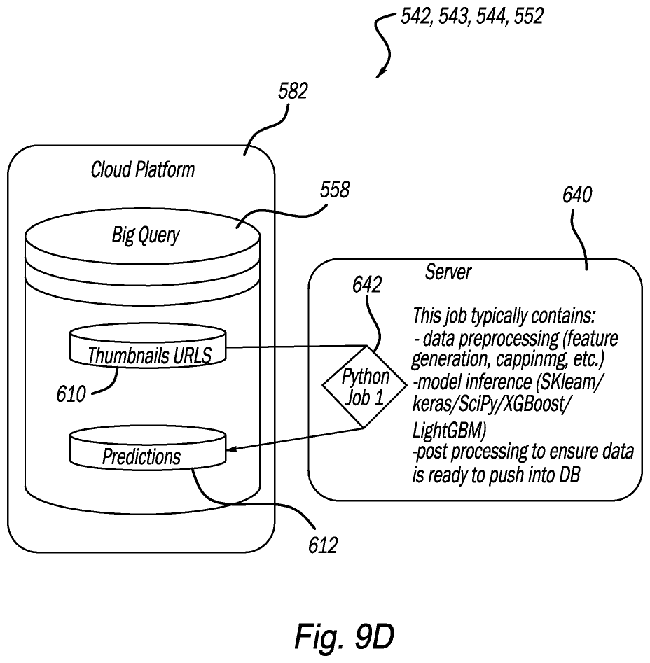

The models and algorithms in the platform 10, or specifically in Darwin 88, power live products. Processes have been developed to be able to source Darwin 88 with up-to-date data, apply the predictive models on this data, and relay this new information through a product. FIGS. 9A-9D are examples of the different architecture's involved in applying the models to the data.

With continued reference to FIG. 1 and additional reference now to FIG. 9A, an exemplary sequence 500 of using the platform 10 will be described. In general, three types of procedures are carried out to leverage the analytics and insight engine 30. The three procedures are generally, the collection of additional metadata (referral data mining), the application of the models, and transformations of the model outputs with pre-existing data. The sequence 500 generally uses a video hosting and distribution system (such as YouTube®) 502, platform data science 504 and platform wider business 506. Video, from the video hosting and distribution system 502 is suggested into the network at 510. The video suggestion 510 flows through a data collection procedure 520, a data enrichment procedure 522 and a data presentation procedure 524. The video suggestion 510 is received at the referral metadata mining module 530. Subsequent to data mining, the data is sent to the production type predictor 540, the genre predictor 542, the sub-genre predictor 543, and the entity extractor 544. Operation of the production type predictor 540 is generally described above with respect to the production style module 100. Operation of the genre and sub-genre predictors 542 and 543 is generally described above with respect the genre/subgenre module 102. Operation of the entity extractor 544 is generally described above with respect to the keyword extractor module 104.

The video suggestion 510 is further received at the age/gender predictor 552. Operation of the age/gender predictor 552 is generally described above with respect to the age/gender module 112. The outputs of the production type predictor 540, the genre and sub-genre predictors 542, 543, the entity extractor 544 and the age/gender predictor 552 flows to the transformation module 560 where the results can be presented through a tableau dashboard 562. The results can be further consumed and leveraged at 570. In some examples, the results can be used to make an action (such as suggest a future video, or suggest a future advertisement or product placement) consistent with the action module 84 (FIG. 2).

With reference now to FIG. 9B, the referral metadata mining module 530 will be described. the video hosting and distribution system only provides an ID of a referring video. Additional metadata such as the video title, thumbnail and description must be collected for the content and audience models 90 and 92 (FIG. 3) to be applied on. The referral metadata mining module 530 ingests millions of video ID's and collects this additional metadata. In FIG. 9B, the video hosting and distribution system is generally identified at 502 and the cloud platform (such as Google Cloud) is generally identified at 582. A reporting application programming interface (API) 584 and a data API 586 are provided by the video hosting and distribution system 502. A big query 588 and cloud storage 590 are provided by the cloud platform 582. In general the big query 588 is an enterprise data warehouse that enables fast structured query language (SQL) queries. The big query 588 includes video on storage 592 and video metadata storage 594. A transfer service 596 transfers data from the reporting API 584 to the video on 592 storage. Python jobs 1, identified at 598 and 600, transfers data from the data API 596 to the video on storage 592 and the cloud storage 590, respectively. A python job 2, identified at 602 transfers data from the cloud storage 590 to the video metadata 594.

With reference now to FIG. 9C, the production style predictor 540 will be described. In general, thumbnail URL's are collected and predictions are made on them using machine learning as a service tool. The big query 588 is shown to include thumbnail URL's 610 and predictions 612. The cloud storage 590 includes thumbnail images 614 and predictions 618. The predictions 618 can be JavaScript Object Notation (JSON) in one example. Google Cloud Platform (GCP) vision AI 620 receives inputs from the thumbnail images 614 and outputs the predictions 618. The server 640 can implement python jobs 1 and 2, identified at 624 and 628, respectively.

With reference now to FIG. 9D, the genre predictor 542, the sub-genre predictor 543, the entity extractor 544 and the age/gender predictor 552 will be described. The Google Cloud Platform 582 is shown to include the big query 558, thumbnails URL's 610 and predictions 612. A python job 1, identified at 642 in the server 640, receives the thumbnail URL's 610 and outputs predictions 612.

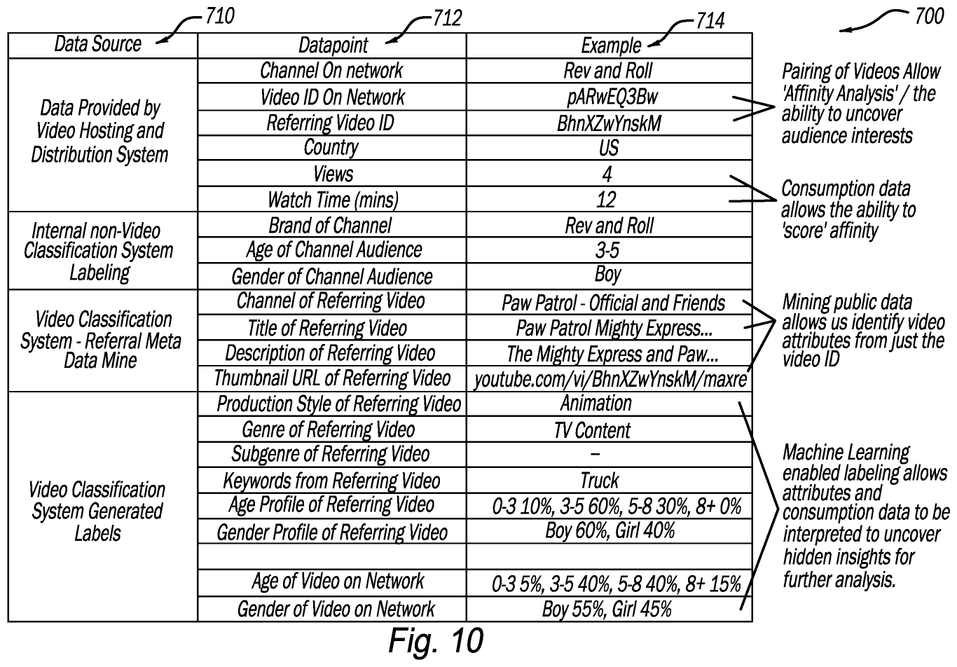

FIG. 10 illustrates core labeling results 700 provided by the video classification system 88. The results 700 are shown in a table having data source 710, datapoint 712 and example 714. In general, data provided by YouTube® can provide many datapoints including a “Channel On Network” including an example, “Rev & Roll”. Other datapoints include “Video ID On Network” including an example, “pARwEQ3Bw”; “Referring Video ID” including an example, “BhnZZwYnskM”; “Country” including an example, “US”; “Views” including an example, “4”; and “Watch time” including the example, “12” minutes. Pairing of videos allows affinity analysis to be performed to understand the audience interests. Similarly, consumption data allows the ability to rank or score an affinity value.

Other data sources include internal non-video classification system labelling. Datapoints 712 and respective examples 714 include: “Brand of Channel”, “Rev & Roll”; “Age of Channel Audience”, “3-5” years; and “Gender of Channel Audience”, “Boy”. Still other data sources include video classification system referral metadata mining data. Datapoints 712 and respective examples 714 include: “Channel of Referring Video”, “Paw Patrol-Official and Friends”; “Title of Referring Video”, “Paw Patrol Mighty Express”; Description of Referring Video”, “The Mighty Express and Paw Patrol”; and “Thumbnail URL of Referring Video”, “youtube.com/vi/BhnXZwYnskM/maxre”. As can be appreciated, mining the publicly available data allows identification of video attributes from just the video ID.

Additional exemplary core labeling results 700 include video classification system generated labels. Datapoints 712 and respective examples 714 include “Production Style of Referring Video”, “Animation”; “Genre of Referring Video”, “TV Content”; “Keywords from Referring Video”, “Truck”; “Age Profile of Referring Video”, “0-3 10%, 3-5 60%, 5-8 30%, 8+0%”; “Gender Profile of Referring Video”, “Boy 60%, Girl 40%”; “Age of Video On Network”, “0-3 5%, 3-5 40%, 5-8 40%, 8+15%”; and “Gender of Video On Network”, “Boy 55%, Girl 45%”.

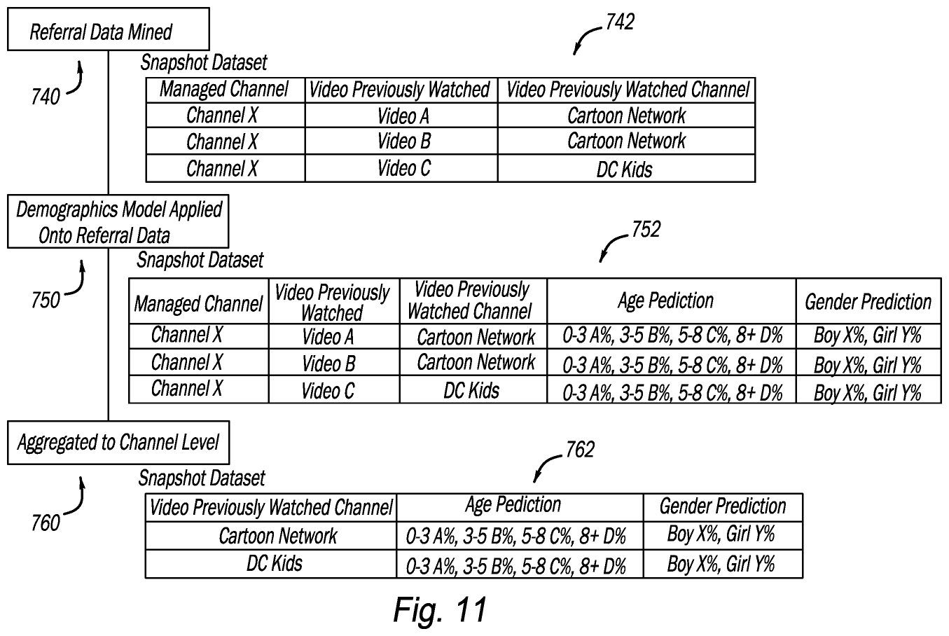

FIG. 11 illustrates Off Network demographics uncovered by the data enrichment layer module 62 (FIG. 2). In particular, referral data is mined at 740 and an exemplary data snapshot 742 is shown. Demographics model is applied onto the referral data at 750 and an exemplary data snapshot 752 is shown. The data is aggregated to the channel level at 760 and a snapshot dataset 762 is shown.

Machine learning enabled labelling allows attributes and consumption data to be interpreted to uncover insights by the insight module 64 for further analysis and potential action at the action module 84. The data enrichment layer module 62 and the insight module 64 can provide a general affinity analysis. For example, it can be shown that audiences on the “Rev & Roll” channel watch “Paw Patrol” for a time duration of three times the amount of the channel average. With this insight, the action module 84 can take action using this information. For example, powerful themes on “Paw Patrol” can be replicated on other shows on the “Rev & Roll” channel as it can be inferred that audiences engage well with such topics. Paid media marketing can be targeted on “Paw Patrol” for more successful campaigns. In other examples, the insight module 64 can determine that shows having a certain topic (for example, “trucks”) as content tend to watch for three minutes on average. This average is two times more than the channel average. As a result, the action module 84 can consider creating more truck themed content to increase interest. Further, it can be shown that the viewers on the “Rev & Roll” channel are typically aged 3-8 and are gender neutral. Advertisers can reach this audience if marketing on the “Rev & Roll” channel, reducing wasted spend on non-target audiences. It may be also shown that audiences that like “truck” themed content are boy skewing. If the goal is to market to more girl skewing audiences, production and distribution of truck themed “Rev & Roll” content can be limited.

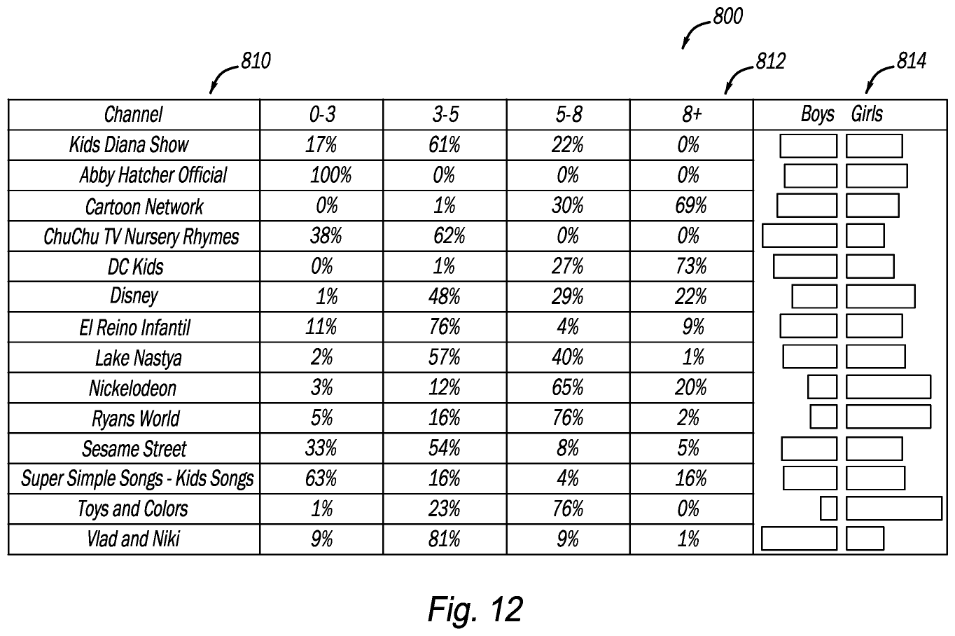

With the reference to FIG. 12, the platform 10 can output predictions 800 related to the audience profile 812 of particular channels 810. In the example shown, the channels are Off Network content 44. In the example shown, the output predictions 800 include age ranges and gender skew analysis.

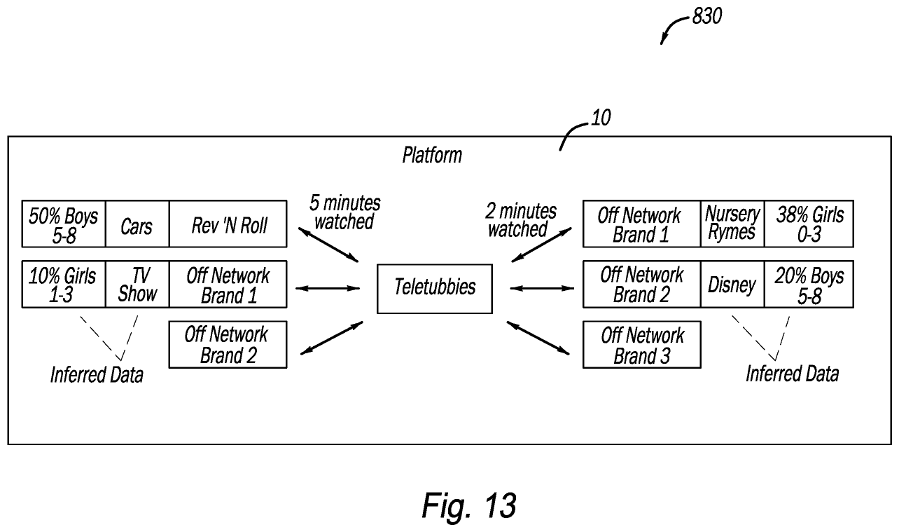

In embodiments, the platform 10 can deploy tools provided by the analytics and insight engine 30 to generate insights at the insight module 64 from the data ingested by the platform 10. By way of these examples, the platform 10 can deploy a tool that is configured to look at the affinity between different brands by assessing viewer behavior, as depicted in FIG. 13. In embodiments, the platform 10 can identify the brands that fans of content particularly like, and their relative appeal. In these examples, it can be determined, for example, what brands Teletubbies® fans also like to watch. In these examples, it can also be determined, for example, what is the relative importance of these other brands to Teletubbies® fans.

In embodiments, the platform 10 can be configured to identify the content that fans of content controlled by the platform 10 (or new to it) may also like to watch, and the platform 10, in doing so, can infer the relative importance of the content to those fans. In embodiments, the platform 10 can determine such relative importance by analyzing how long a viewer of a referring video spends watching one of the videos from the On Network content 42. In the examples in FIG. 13, the viewer that had previously been watching “On Network Brand 1” (such as in Rev & Roll® for example) on a network controlled by the platform 10 went on to watch five minutes of Teletubbies® content, but the viewer of “Off Network Brand 1”, which is not controlled by the platform 10, only watched two minutes. In these examples, the platform 10 can determine that the viewer of “On Network Brand 1” had a greater affinity with Teletubbies® content than the viewer of “Off Network Brand 1”, even though “Off Network Brand 1” content may not be controlled by the platform 10. By using the amount of time spent watching content controlled by the platform 10 (because of the predetermined and in depth knowledge on which the analytics and insight engine 30 can be trained), the platform 10 can create a measurable index (e.g., a score) that can detail a rank of the relative affinity between different brands.

In embodiments, the platform 10 can mine the other data such as referral videos to generate additional insights. By way of these examples, each referral video has other pieces of data that the platform 10 can access and can infer valuable data from, including, e.g., keywords that describe the video, and information about the publisher of the video. In embodiments, the platform 10 analyzed such data and can aggregate it to provide additional ways of categorizing the interests of the fans of videos known by the platform 10 or which such insights are requested.

With continued reference to FIG. 13, brand affinity examples are shown according to one example. Multiple examples are detailed where the metadata is depicted. By way of these examples, “Off Network Brand 1” can be tagged with “Nursery Rhymes” and “Off Network Brand 2” (such as “Frozen”, for example) with “Disney”. In embodiments, the platform 10 can create clusters of videos that share these tags and can understand where those viewers land on one or more networks controlled (or understood) by the platform 10 and with what content such viewers engage. In embodiments, the analytics and insight engine 30 is configured to classify videos into content buckets. By way of example, the analytics and insight engine 30 can tag an “Off Network Brand 1” with “nursery rhyme” or tag a video about a child playing with slime with “arts and crafts”. The analytics and insights engine 30 reads in raw data (such as video title, description, keywords, etc.) from videos provided by the content library 40. The analytics and insights engine 30 can then identify the closest genre in the taxonomy from this data and output clusters of content (i.e., toy play for 3-5-year-old boys or TV content for 8 year and older girls). The clusters can then be viewed through the hosting and distribution system 20.

In embodiments, the platform 10 can apply demographic data to content observed by the platform 10. The platform 10 can identify the profile of the audience that is determined to be watching the content based on insights from the platform 10 and one or more third party sources. By tracing the traffic between content controlled by the platform 10 and referral videos, the platform 10 can then infer a more detailed audience profile for brands (affiliated with, etc.) one or more networks controlled by the platform 10 and can further infer the audience profile of videos that are external to the one or more networks (not controlled by the platform 10).

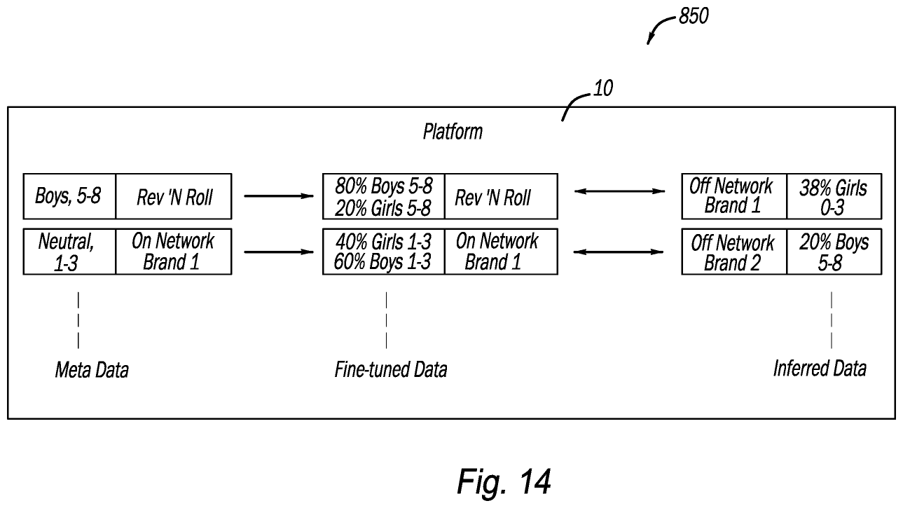

With additional reference to FIG. 14, examples of demographic metadata leads facilitating demographic inferences are shown generally at 850. The orange boxes on the left of the graphic indicate the demographic data that can be applied by the platform 10, and the lighter orange boxes on the right indicate the predictions the platform 10 can make about the audience viewing content off content (i.e., for which the platform 10 had to infer). By way of these examples, the platform 10 can be configured to host the official channel for “On Network Brand 1” at the hosting and distribution system 20, and insights from other sources can be obtained by the platform to support an indication by the platform 10 that it has a gender neutral audience aged 1-3. By tracking videos that refer through and into the platform 10, the platform can fine-tune its understanding of the demographic profile of, for example, “On Network Brand 1” and can deduce one or more conclusions such as 40% of its audience are girls aged 1-3 and 60% are boys aged 1-3. By tracking the videos that refer traffic into “On Network Brand 1”, it can be shown that the platform 10, in embodiments, can then infer the demographic profile of the audience that's being referred into the channel. By way of these examples, the platform 10 can predict that 38% of “Off Network Brand 1” audience was 0-3-year-old girls, and 20% of “Off Network Brand 2” audience was 5-8-year-old boys.

The platform 10 can identify the types of content that toy focused videos can deliver to three channels on one or more networks for which control by the platform 10 can provide the predetermined and in depth knowledge such as Kiddyzuzaa®, Rev & Roll® and Teletubbies® content. Content genre can be filtered, e.g., Toy Focused. The On Network channels and brands that are being assessed. The relative importance of the different types of toy play content for each of the channels can be determined. The Keywords of the referring videos for each of the three channels being analyzed, e.g., highlighting that videos with the keyword ‘Barbie’ deliver the greatest amount of viewing to videos on the Kiddyzuzaa® channel. The foregoing by way of example, but without limitation to the filters and affinity analytics that may be realized. The platform 10 can identify and depict where viewers associated with the word ‘Disney’ land on the one or more networks for which control by the platform 10 can provide the predetermined and in depth knowledge, and where they engage most strongly with content, which, in turn, can generate a high score for affinity.

In embodiments, the platform 10 can understand the types of content that resonate with fans of shows, which can enable the platform 10 to control (create, obtain, etc.) content fans of the platform 10 are more likely to enjoy. In embodiments, the platform 10 can also determine what other types of content Teletubbies® fans watch, e.g., animation, toy play, music videos, educational videos, etc. In embodiments, the platform 10 can also determine how important are these other types of content to Teletubbies® fans.

In embodiments, the platform 10 can also apply different layers of targeting that do not rely on data that can be personally identifiable (and is therefore compliant with regulations such as COPPA and the like). By way of these examples, the platform 10 can also apply different layers of targeting that can include the brands liked by audiences of the platform 10. The platform 10 can also apply different layers of targeting that can include content/channels watched when one or more audiences are not watching through one or more networks controlled by the platform 10. The platform 10 can further apply different layers of targeting that can include other signals such as the type of content, or the publisher of the content, etc. In embodiments, the platform can determine age and gender profiles for the other channels on one or more networks controlled by the platform 10 based on the internal referrals of traffic to content that can be tagged by the platform 10. In embodiments, the platform 10 can determine what the age and gender profiles are for the channels that refer into one or more networks for which control by the platform 10 can provide the predetermined and in depth knowledge. The platform 10 can determine an output identifying the age profile of Kiddyzuzaa® fans based on the content they watch elsewhere on one or more networks for which control by the platform 10 can provide the predetermined and in depth knowledge.

In embodiments, the platform 10 can identify channels, and videos, that are particularly successful at referring in traffic to one or more networks for which control by the platform 10 can provide the predetermined and in depth knowledge that can be used to train the analytics and insights engine 30. By understanding the content on those channels, and how it is promoted/tagged, the platform 10 can adjust channel operations to better align with recommendation algorithms (or other algorithms or methodologies, as applicable, such as provided by the hosting and distribution system 20) leading to more recommendations and more views of On Network content.

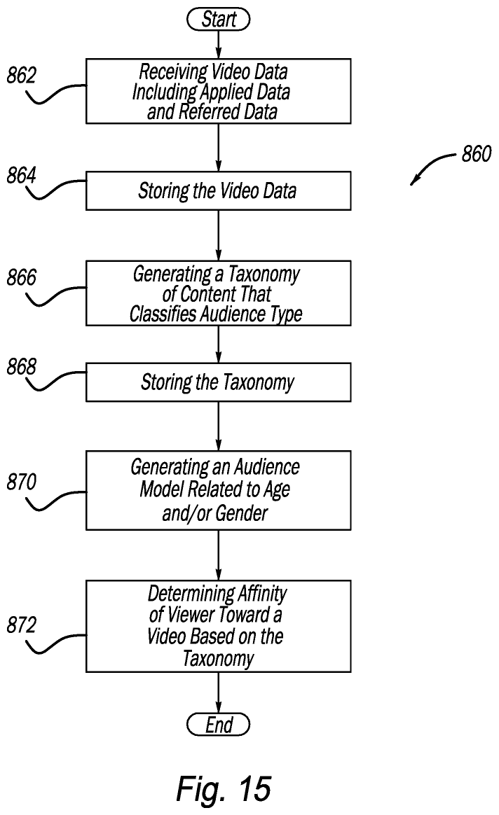

FIG. 15 shows an exemplary computer-implemented method of determining a demographic associated with a viewer that watches a video. The method is generally identified at reference 860. Video data including applied data and referral data is received at 862. The applied data has metadata that describes content of a first collection of videos. The referral data has data associated with a second collection of video that were previously viewed before the selected video and referred to the selected video. The video data is stored at 864. A taxonomy of content that classifies audience type is generated at 866. The taxonomy is stored at 868. An audience model related to age and/or gender is generated at 870. The audience model has a dataset related to at least one of age and gender of the viewer that watches the selected video. An affinity of the viewer toward a video based on the taxonomy is determined at 872.

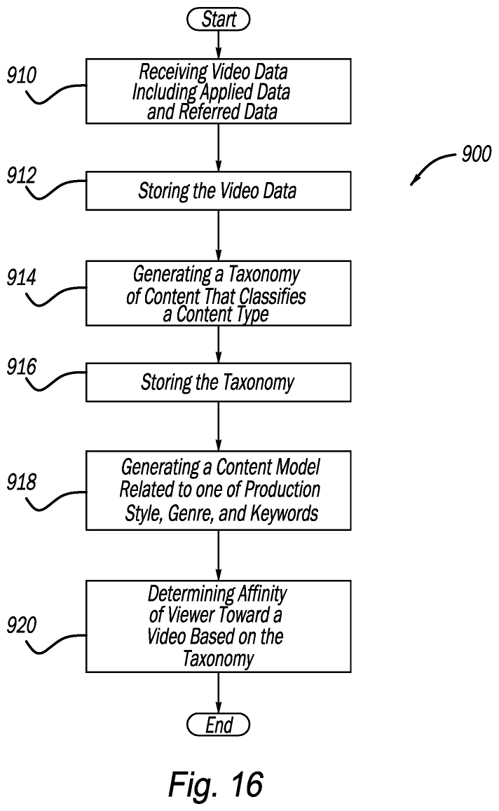

FIG. 16 shows an exemplary computer-implemented method of determining a characteristic associated with a selected video. The method is generally identified at reference 900. Video data including applied data and referral data is received at 910. The applied data has metadata that describes content of a first collection of videos. The referral data has data associated with a second collection of video that were previously viewed before the selected video and referred to the selected video. The video data is stored at 912. A taxonomy of content that classifies content type is generated at 914. The taxonomy is stored at 916. A content model related to production style, genre and keywords is generated at 918. An affinity of the viewer toward a video based on the taxonomy is determined at 920.

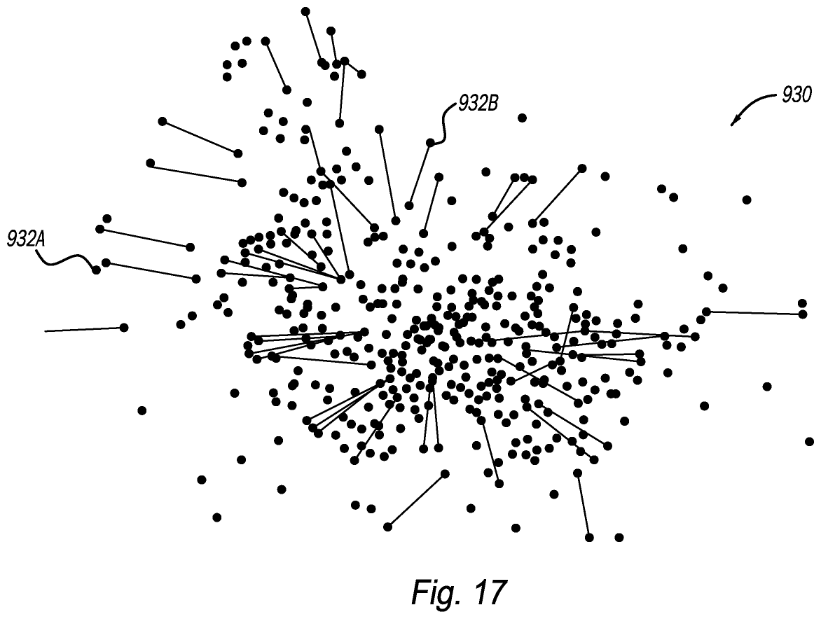

With additional reference now to FIGS. 17-21, additional features of the computer system and associated methods will be further described. The present disclosure provides a video intelligence platform for inferential determination of viewer group information that determines a demographic associated with a viewer group that watches a selected video. An affinity of the viewer group toward a particular video is determined based on the taxonomy of the content and similarity and clustering for a video intelligence platform based on the machine learning and artificial intelligence techniques described herein for understanding video content for a video intelligence platform.

The computer system and methods described herein can scan through content of selected videos and analyze frame by frame the content. In this regard, the characters being viewed, what elements are such characters interacting with, what are their emotions and other aspects can be determined and categorized. The computer system and methods can determine themes and events associated with particular characters and group common themes based on similar content. Furthermore, the system and methods can determine the journey of a particular viewer. A journey can be defined as an analysis of what episodes a particular viewer may watch previous to and subsequent to a given video. Various determinations can be made such a viewer following a particular character or theme from one video to the next. The network can then be predicted for a given viewer based on gathering of such information. In examples, common themes can be mapped out. Identifying particular themes (videos with footballs, tractors, dolls, cars, etc.) can then be used to suggest future content desired by the viewer. Moreover, episodes can be identified that are likely to resonate with a particular viewer based on identified themes. Advertising can be targeted with content likely to be of interest with a particular viewing habit. By way of example, if an advertiser wishes to target a viewer that is interested in a subject (i.e., a football), the systems and methods herein can suggest a particular cluster of episodes with viewers with particular interest in that subject (i.e., footballs). As described above, the methods herein do not rely on audience personal characteristics as no access to them is provided and YouTube® does not capture such audience personal characteristics. The methods described herein are based on viewer numbers by media asset and an understanding of that video content to calculate an audience map to determine their likely interests, demographics and affinity.

The computer system and methods described herein can generate a network map 930, as shown in FIG. 17, that can correlate the affinity between video through not just taxonomy but through proximity of similarities of the video content through common characteristics of the content (animation type, characters, situations and events) along with referral data to create cluster maps of brand and video affinity. As illustrated in FIG. 17, each dot (such as 932A, 932B, etc.) is an associated mapping of brands and their relationships with other brands. The stronger the line, the closer the affinity based on taxonomy along with video intelligence data. In examples, FIG. 17 is a brand network map that visualizes the traffic data where the number and weight of edges represent brand relationships.

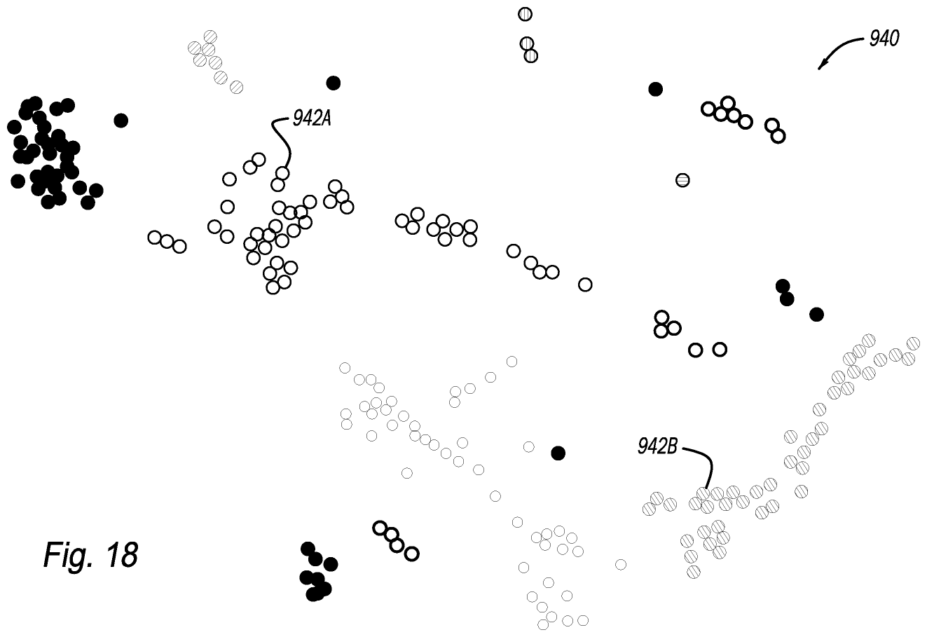

Turning to FIG. 18, an audience segmentation map 940 generated by the computer system and methods of the present disclosure is shown. The audience map 940 is a creation of segmentation profiles of audience demographics where audiences are clustered into common segments that share characteristics. All characteristics are inferential determination consistent with COPPA compliance as the computer systems and methods herein do not have access to any viewer data or individual characteristics. Using artificial intelligence modelling, based on the viewer group information and relationships between the content, common taxonomy and correlations of content events, audience segmentation profiles can be created and generated. As shown in FIG. 18, each dot 942A, 942B, etc., is an audience segmentation profile. The size of the dot represents the number of audience members mapping to that segmentation determined based on their viewer behavior alone. The proximity of dots to each other is based on characteristics. Colors can determine the strength of affinity between segmentation groups.

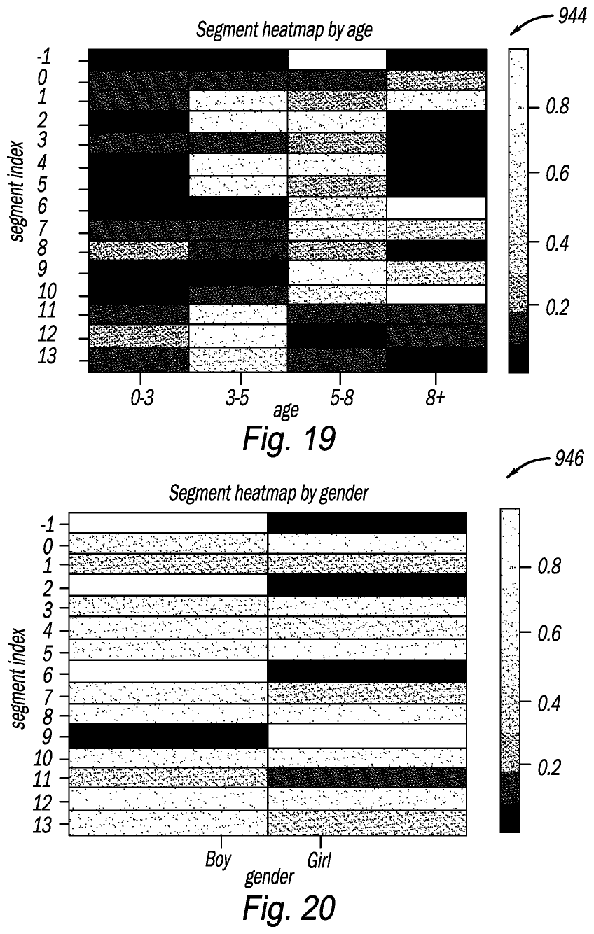

The system and methods described herein can use the segmentations and taxonomy characteristics along with video intelligence data to generate demographic characteristic maps for each segment. FIG. 19 illustrates a segment heatmap 944 by age for a specific segment. In the example shown, the closest map is for the 3-5 year age group. FIG. 20 illustrates a segment heatmap 946 for gender. In the example shown, a bias is identified toward the boy gender.

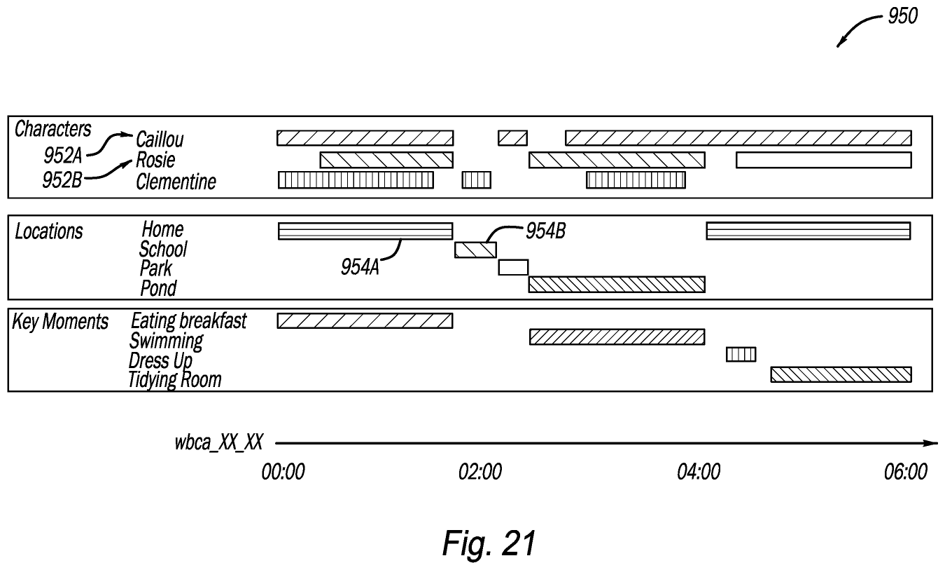

FIG. 21 illustrates a characteristic chart 950 generated by the computer system and methods disclosed herein. The chart 950 identifies lanes 952A, 952B, etc., corresponding to a particular episode characteristic or feature 954A, 954B, etc., calculated as a function of time. In the example shown, an episode of Caillou® identifies characters, locations and key moments.

In examples, viewer levels may be forecasted based on segmentation behaviors. New video content and brands can be assessed through the modelling against the audience segments to determine an affinity score. A segmentation forecasted engagement is calculated with a specific brand of video based on an assessment of the content, taxonomy, and video characteristics. The systems and methods can determine whether the content is going to reach the desired and intended segments. An affinity score can be calculated by dividing the percent content mapping (based on the video intelligence matching) by alignment of the channel characteristics to a specific segment. A channel affinity score of 1 indicates the two values are the same and this particular channel would receive the expected amount of traffic from this content and it is meeting the intended audiences. If a channel's affinity score is larger than 1, it indicates this channel receives more traffic from the content than can be expected, and therefore, the content is a very good match for the intended segment. This suggests that the channel's audience has a greater interest and engagement with this content than expected. Similarly, if the channel's affinity score is less than 1, it indicates that the channel's audience has a reduced interest and engagement with the content than expected.

The systems and methods described herein can deliver the desired content to the correct viewer at the optimal time. In other advantages, the segmentation profiles described above can establish particularly valuable advertising opportunities. In this regard, as the systems and methods described herein can identify particular characteristics, and group such characteristics between various content, whereby particular advertisers selling similar content can target advertising during episodes that share similar content.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

In the included description, numerous specific details are set forth to provide a thorough understanding of the presently disclosed technology. In other embodiments, the techniques introduced here can be practiced without these specific details. In other instances, well-known features, such as specific functions or routines, are not described in detail in order to avoid unnecessarily obscuring the present disclosure. References in this description to “an embodiment,” “one embodiment,” or similar terms with “embodiment” mean that a particular feature, structure, material, or characteristic being described is included in at least one embodiment of the present disclosure. The appearances of such phrases in this specification do not necessarily all refer to the same embodiment. On the other hand, such references are not necessarily mutually exclusive. Furthermore, the particular features, structures, materials, or characteristics can be combined in any suitable manner in one or more embodiments.

It is to be understood that the various embodiments shown in the figures are merely illustrative representations. Further, the drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the disclosure can be operated in any orientation.

Several details describing structures or processes that are well-known and often associated with computer systems and subsystems, but that can unnecessarily obscure some significant aspects of the disclosed techniques, are not set forth in the included description for purposes of clarity. Moreover, although this disclosure sets forth several embodiments of different aspects of the present technology, several other embodiments can have different configurations or different components than those described in this section. Accordingly, the disclosed techniques can have other embodiments with additional elements or without several of the elements described below.

Many embodiments or aspects of the present disclosure described herein can take the form of computer-executable or controller-executable instructions, including routines executed by a programmable computer or controller or electronic devices. Those skilled in the relevant art will appreciate that the disclosed techniques can be practiced on electronic or computer or controller systems other than those shown and described below. The techniques described herein can be embodied in a special-purpose electronic or computer or data processor that is specifically programmed, configured, or constructed to execute one or more of the computer-executable instructions described herein. Accordingly, the terms “computer” and “controller” as generally used herein refer to any data processor and can include servers, distributed computing systems, cloud computing, internet appliances, and handheld devices, including palm-top computers, wearable computers, cellular or mobile phones, multi-processor systems, processor-based or programmable consumer electronics, network computers, mini computers, and the like. Information handled by these computer systems and computers and controllers can be presented at any suitable display medium, including a liquid crystal display (LCD). Instructions for executing electronic- or computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable mediums.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements cooperate or interact with each other (e.g., as in a cause-and-effect relationship, such as for signal transmission/reception or for function calls), or both.

The embodiments herein are described in sufficient detail to enable those skilled in the art to make and use the disclosure. It is to be understood that other embodiments would be evident based on the present disclosure, and that system, process, or mechanical changes may be made without departing from the scope of an embodiment of the present disclosure.

The term “module” or “unit” referred to herein can include software, hardware, mechanical mechanisms, or a combination thereof in an embodiment of the present invention, in accordance with the context in which the term is used. For example, the software can be machine code, firmware, embedded code, or application software. Also, for example, the hardware can be circuitry, a processor, a special purpose computer, an integrated circuit, integrated circuit cores, a pressure sensor, an inertial sensor, a microelectromechanical system (MEMS), a passive device, or a combination thereof. Furthermore, the mechanical mechanism can include actuators, motors, arms, joints, handles, end effectors, guides, mirrors, anchoring bases, vacuum lines, vacuum generators, liquid source lines, or stoppers. Further, if a “module” or “unit” is written in the system claims section below, the “module” or “unit” is deemed to include hardware circuitry for the purposes and the scope of the system claims.

The modules or units in the description of the embodiments can be coupled or attached to one another as described or as shown. The coupling or attachment can be direct or indirect without or with intervening items between coupled or attached modules or units. The coupling or attachment can be by physical contact or by communication between modules or units.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the processor may be a dual core processor, quad core processors, other chip-level multiprocessor and the like that combine two or more independent cores (sometimes called a die).

The methods and systems described herein may be deployed in part or in whole through a machine that executes computer software on a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described above and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference as if fully set forth herein. The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A computer-implemented method of determining a demographic associated with a viewer that watches a selected video, the method comprising:
receiving, at a computing device having one or more processors, video data including applied data and referral data, the applied data having metadata that describes content of a first collection of videos, the referral data having data associated with a second collection of videos that were previously viewed before the selected video and referred to the selected video;
storing, at the computing device, the video data;
generating a taxonomy of content that classifies an audience type of the video data;
storing, at the computing device, the taxonomy;
generating an audience model based on the taxonomy, the audience model having a dataset related to at least one of age and gender of the viewer that watches the selected video;
generating a content model based on the taxonomy, the content model having a dataset related to at least one of production style, genre, and keywords of the selected video; and
determining an affinity of the viewer toward a particular video based on the taxonomy of the content.

2. The computer-implemented method of claim 1 wherein determining the affinity of the viewer toward the particular video comprises:
identifying a first timeframe of viewing the selected video from a first viewer that previously watched a first prior video;
identifying a second timeframe of viewing the selected video from a second viewer that previously watched a second prior video;
determining whether the first timeframe or the second timeframe is longer; and
assigning a greater affinity to the respective first and second prior video based on the determined longer timeframe.

3. The computer-implemented method of claim 1, further comprising:
generating clusters of videos that share characteristics within the audience model and the content model.

4. The computer-implemented method of claim 3, further comprising:
targeting future content based on the clusters of videos, wherein the future content comprises one of future videos and future advertising.

5. The computer-implemented method of claim 3 wherein the characteristics comprise one of a gender of the viewer that watches the selected video and an age range of the viewer that watches the selected video.

6. The computer-implemented method of claim 5 wherein the age range is a viewer under 13 years, wherein the age range includes age groups selected from at least one of 0-3 years, 3-5 years, 5-8 years and over 8 years.

7. The computer-implemented method of claim 3 wherein the characteristics comprise a geographic location of the viewer that watches the selected video.

8. The computer-implemented method of claim 1, wherein the content model has a dataset related to production style comprising one of animation and live action.

9. The computer-implemented method of claim 8 wherein generating the content model comprises:
receiving, at the computing device, an image thumbnail of the selected video; and
determining whether the production style is one of animation and live action based on the image thumbnail.

10. The computer-implemented method of claim 1 wherein the content model includes a dataset related to one of (i) a genre of the video data, wherein the genre comprises at least one of arts, crafts, friends, family, transportation, sports, and games; and (ii) keywords.

11. The computer-implemented method of claim 1 wherein the video data comprises at least one of (i) an amount of views of videos in the first and second collection of videos, (ii) a watch time of videos in the first and second collection of videos; (iii) a country that videos in the first and second collection of videos are being watched in; and (iv) a channel that videos on the first and second collection of videos are being watched on.

12. The computer-implemented method of claim 1, further comprising:
determining an affinity score based on (i) common characteristics of the video content and the referral data, and (ii) a content mapping divided by an alignment of channel characteristics to a particular segment;
generating a network map that correlates the affinity based on proximity of similarities of video content; and
generating an audience segmentation map having a plurality of dots representing viewer behavior, wherein a proximity of dots to each other is based on common characteristics of video content.

13. A computer system comprising:
at least one processor configured to:
receive, at a computing device having one or more processors, video data including applied data and referral data, the applied data having metadata that describes content of a first collection of videos, the referral data having data associated with a second collection of videos that were previously viewed before the selected video and referred to the selected video;
store, at the computing device, the video data;
generate a taxonomy of content that classifies an audience type of the video data;
store, at the computing device, the taxonomy;
generate an audience model based on the taxonomy, the audience model having a dataset related to at least one of age and gender of the viewer that watches the selected video;
generate a content model based on the taxonomy, the content model having a dataset related to at least one of production style, genre, and keywords of the selected video; and
determine an affinity of the viewer toward a particular video based on the taxonomy of the content.

14. The computer system of claim 13 wherein the at least one processor is further configured to:
identify a first timeframe of viewing the selected video from a first viewer that previously watched a first prior video;
identify a second timeframe of viewing the selected video from a second viewer that previously watched a second prior video;
determine whether the first timeframe or the second timeframe is longer; and
assign a greater affinity to the respective first and second prior video based on the determined longer timeframe.

15. The computer system of claim 14 wherein the at least one processor is further configured to:
generate clusters of videos that share characteristics within the audience model; and
target future content based on the clusters of videos, wherein the future content comprises one of future video and future advertising.

16. The computer system of claim 13 wherein the characteristics comprise at least one of (i) a gender of the viewer that watches the selected video; and (ii) an age range of the viewer that watches the selected video, wherein the age range is a viewer under 13 years and wherein the age range further comprises age groups that are selected from at least one of 0-3 years, 3-5 years, 5-8 years and over 8 years.

17. The computer system of claim 13, wherein the one or more processors are configured to:
generate a content model having a dataset related to production style, wherein the production style comprises one of animation and live action, wherein the one or more processors are further configured to:
receive, at the computing device, an image thumbnail of the selected video; and
determine whether the production style is one of animation and live action based on the image thumbnail.

18. A computing device for determining a demographic associated with a viewer that watches a selected video, the computing device comprising:
one or more processors; and
a non-transitory computer-readable storage medium having multiple instructions stored thereon, which, when executed by the one or more processors, cause the one or more processors to perform operations comprising:
receiving, at the one or more processors, video data including applied data and referral data, the applied data having metadata that describes content of a first collection of videos, the referral data having data associated with a second collection of videos that were previously viewed before the selected video and referred to the selected video;
storing, at the one or more processors, the video data;
generating a taxonomy of content that classifies an audience type of the video data;
storing, at the one or more processors, the taxonomy;
generating an audience model based on the taxonomy, the audience model having a dataset related to at least one of age and gender of the viewer that watches the selected video;
generating a content model based on the taxonomy, the content model having a dataset related to at least one of production style, genre, and keywords of the selected video; and
determining an affinity of the viewer toward a particular video based on the taxonomy of the content.

19. The computing device of claim 18 wherein determining the affinity of the viewer toward the particular video comprises:
identifying a first timeframe of viewing the selected video from a first viewer that previously watched a first prior video;
identifying a second timeframe of viewing the selected video from a second viewer that previously watched a second prior video;
determining whether the first timeframe or the second timeframe is longer; and
assigning a greater affinity to the respective first and second prior video based on the determined longer timeframe;
generate clusters of videos that share characteristics within the audience model; and
target future content comprising one of (i) future videos and (ii) future advertising based on the clusters of videos.

20. The computing device of claim 19 wherein the characteristics comprise at least one of (i) a gender of the viewer that watches the selected video; and (ii) an age range of the viewer that watches the selected video, wherein the age range is a viewer under 13 years and wherein the age range further comprises age groups that are selected from at least one of 0-3 years, 3-5 years, 5-8 years and over 8 years.
